(19) United States
(12) Patent Application Publication
(10) Pub. No.: US 2004/0265472 A1
(43) Pub. Date: Dec. 30, 2004

(54) Low water activity cold-process ice cream toppings

(76) Inventors: Susan Amy Corfman, Orrville, OH (US); James Andrew Jindra, Wooster, OH (US); Mark Stephen Grucza, Wadsworth, OH (US); John P. Hansen, Wadsworth, OH (US); Jim P. McAllister, Orrville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/829,709

(22) Filed: Apr. 22, 2004

Related U.S. Application Data
(60) Provisional application No. 60/464,474, filed on Apr. 22, 2003.

(51) Int. Cl. A23C 1/00

(52) U.S. Cl. 426/650

(57) ABSTRACT

Low water activity (A_{w}) food products, particularly ice cream toppings, with or without inclusions, multi-phased ice cream toppings with or without inclusions, and a cold-process method for making such low A_{w} ice cream toppings. The low A_{w} ice cream toppings include, by weight, 0.05 to 40% flavoring agent; 0.01 to 50% fat, having a melting point in the range from 35° to 150° F.; 0.1 to 40% humectant; up to 80% sweetener; up to 10% emulsifier; and 0 to 20% water. The water activity of these food products is generally less than 0.85, and preferably less than 0.7. These low A_{w} food products are particularly well suited for preparing multi-phase products, as well as maintaining the taste and texture inclusions, particularly nuts, candies, and candy bar bits. The low A_{w} food products of the present invention have desirable flavor and texture, and maintain these characteristics when heated. Because of their low water activities, the low A_{w} food products of the present invention do not require refrigeration after opening.

### CROSS-REFERENCE TO RELATED APPLICATIONS

This application claims priority to U.S. Provisional Patent Application No. 60/464,474 filed Apr. 22, 2003, the entirety of which is incorporated herein by reference.

### BACKGROUND OF THE INVENTION

The retail ice cream topping category has become saturated with practically every conceivable flavor, and a quest for uniqueness is becoming essential to growth of the category. One potential avenue of pursuit involves striping two or more complimentary toppings together in the same jar. Interaction between different phases (such as chocolate and caramel) has curtailed exploration of this avenue, since traditional toppings are water-based and water migration between the two phases results in visual and flavor defects. The Smucker's Goober® peanut butter and jelly product is an example of a product with two phases which have very different water activities, the peanut butter phase being very low water activity and the jelly phase being relatively high water activity. Because of this differential, rancidity develops over time as moisture migrates from the region of high water activity to the region of low water activity, thereby shortening shelf life. Also, an undesirable “fuzzy” discoloration occurs along the plane of contact between the two phases.

Another avenue in the pursuit of uniqueness is the development of toppings that contain inclusions such as nuts, crumbs and candies. Water migration from traditional toppings into the inclusions leads to texture and flavor degradation of the inclusions. Not only do the inclusions become soft, but the texture of the topping itself changes over time, becoming noticeably less creamy and more stiff due to moisture transfer to the inclusions. One way that inclusions could be added to conventional ice cream is by using an entirely fat-based topping, which could prevent phase interaction. However, a topping of this nature would present palatability and textural challenges.

Another problem with adding inclusions to conventional water-based toppings, is that water-based toppings provide a good growth medium for bacteria, and therefor, a hot-fill process, typically employing temperatures greater than 160° F., is required in the preparation of ice cream toppings. The heat from the process can further degrade inclusions. Additionally, once these water-based toppings are opened, they must be refrigerated to prevent the growth of microorganisms.

Furthermore, the process used to make traditional ice cream toppings is lengthy and complex, and requires quite an expenditure of energy, heat, time, and labor, with pitfalls inherent in each step.

Accordingly, it would be desirable to have new topping formulations that provide a product having the desirable characteristics of traditional ice cream toppings: flavor, mouthfeel, spoonability, cling characteristics, and microwave stability. It is also desirable that the formulation and process of making the toppings allows for the production of multi-phased products yet allow each phase to maintain its characteristics without shortening shelf life. It is further desirable to formulate and produce ice cream toppings that maintains the crispness/crunchiness of low-moisture inclusions. It is further desirable to have an ice cream topping, or other topping that is adaptable to multiphase products, such as chocolate/caramel, marshmallow/chocolate, wherein a variety of low-moisture inclusions, such as candies, candy bits, candy bar bits, toffee bits, granola, cookie bits, and various nut meats, for example, can be used. It is further desirable to produce low A_{w} toppings that possess textural and functional attributes (i.e., microwavability) of higher A_{w} toppings despite its low A_{w}. It is further desired that the formulation technology can be easily adapted to flavors ranging from chocolate to strawberry. It is further desirable to have an ice cream topping, or other topping that is shelf stable (i.e., does not require refrigeration) before and after opening.

It is desired from a manufacturing standpoint to develop a process for making ice cream or other toppings that involves a low capital start-up investment. It is further desirable to develop a process for making ice cream or other toppings that eliminates the need for heating, cooking, vacuuming, homogenizing and pasteurizing the topping, which is a significant saving of time, energy and other resources. It is further desirable to have an ice cream topping or other topping that can be filled at very low fill temperatures (less than 120° F.) without compromising microbial stability. It is further desirable for the manufacturer to have the flexibility in preparing to be able to produce the ice cream topping or other topping in bulk containers and store for later use, or to produce the ice cream topping or other topping as part of a continuous process in which it is incorporated immediately into the final retail container. It is even further desirable that when the topping is produced in bulk containers and stored for later use, it can easily be repackaged in either single-phase or multi-phase embodiments.

### SUMMARY OF THE INVENTION

The present invention relates to low water activity (“low A_{w}”) food products, specifically low A_{w} ice cream toppings, icings, dessert spreads, sandwich spreads, confections, fillings, and savory sauces, dips, and so forth. The low A_{w} food product is formulated to have a high solids content and a low water activity. The solids content of the low A_{w} food product typically constitutes a majority of the composition. The water activity of the low A_{w} food product is generally selected so as to allow the low A_{w} food product to be able to be stored, even after opening, at room temperature. The A_{w} of the food product is further chosen to allow inclusions, such as crumbs, nuts, candies, and so forth, to be added to the low A_{w} food product without degradation that results when inclusions are added to higher water activity foods. The A_{w} is further chosen to allow the production of a multi-phase product wherein reactions between phases, as a result of water transfer, is minimized. The low A_{w} food product is formulated to maintain the sweetness, flavor, and other desired organoleptic characteristics while maintaining a low water activity.

To achieve the low A_{w}, the food products of the present invention are formulated to have a high solids content, generally greater than 80% solids, preferably more than 85% solids, and even more preferably more than 90% solids, while maintaining the desirable flow and texture characteristics of conventional food products. The viscosity of the low A_{w} food product is such that it can be pumped, extruded, packaged and stored in a manner similar to that of other ice cream toppings, icings, dessert spreads, sandwich spreads, confections, confectionary fillings, and savory sauces. Additionally, because of the low A_{w}, the food products of the present invention are resistant to microbial growth. Accordingly, unlike conventional ice cream toppings, the food products of the present invention do not have to be refrigerated after opening. The low A_{w} food products of the present invention are also microwave stable, maintaining their desirable characteristics, such as mouthfeel, texture, consistency, spoonability, flow, cling characteristics, and flavor when heated. The present invention further relates to methods of making these food products.

The low A_{w} food product of the present invention comprises about 0.05% to about 40% by weight flavor agent; about 0.01% to about 30% by weight of a liquid oil; about 0.01% to about 5% by weight of a high melting point oil; about 0.01% to about 25% by weight humectant; about 1% to about 50% by weight sweetener; about 0.01% to about 5% by weight emulsifier; and a water activity of less than about 0.85. In another aspect, the present invention further comprises inclusions. The inclusions can be virtually any low A_{w} additive that is desirable in the low A_{w} food composition. Some exemplary inclusions include crumbs, pie crust, cookies, cake pieces, brownie pieces, dehydrated marshmallows, crackers, nuts, nut meats, roasted nuts, seeds, oats, candies, confections, chocolates, hard candies, gum, chocolate chunks, chocolate chips, panned or molded chocolate candy, malted milk balls, candy-coated chocolates, such as M&M's®, candy bar bits, such as SNICKERS® bits, MILKY WAY® bits, BUTTERFINGER® bits, and the like.

In another aspect of the invention, the low A_{w} food product includes a combination of edible oils and humectant to achieve the low water activity of the low A_{w} food product. The edible oil and the humectant are, in one sense, used as a partial or full substitute for water in the low A_{w} food product, as compared to a typical food product or topping, thus enabling the low A_{w} food product to be formulated with a low water activity. The edible oil and humectant also function to fluidize and plasticize the low A_{w} food product thereby facilitating in dispersing other components of the low A_{w} food product when added to low A_{w} food product during the manufacturing of the low A_{w} food product. The edible oil and humectant further facilitate the low A_{w} food product being easily processed (i.e. pumped, stirred, mixed, extruded, etc.) during the manufacturing of the low A_{w} food product. The high melt point oil also functions as a high temperature stabilizing agent for the low A_{w} food product when the final low A_{w} food product is exposed to temperatures above ambient temperature. The humectant also functions to bind the components of the low A_{w} food product together.

The fat or oil of the present invention is preferably a vegetable fat, though other edible fats could be used as well. Preferably the fats are vegetable fats. The fats used in the present invention can be natural, partially hydrogenated, hydrogenated, or a combination thereof. The fat of the present invention is preferably a combination of two or more fats: a liquid oil and a high melt point oil having a melting point in the range from 95° F. to 155° F. The liquid oil can be unhydrogenated or partially hydrogenated, preserved (e.g. with TBHQ, BHT, or other preservative) or unpreserved. The liquid oil may also have lecithin or other emulsifiers added to enhance smoothness, mouthfeel, or create an oil that is more heat stable and/or shelf stable. The high melting point oil preferably has a melting point in the range from about 95° F. to about 155° F. Some preferred vegetable fats include: soybean, cottonseed, canola, rapeseed, peanut, safflower, sunflower, coconut, palm, palm kernel, olive, butterfat, cocoa butter, tallow, lard, corn, and combinations thereof.

The humectant of the present invention is selected from the group consisting of glycerin, 1,3-butyl glycol, mannitol, sorbitol, fructose, propylene glycol, and combinations thereof. Preferably, the humectant is selected from glycerin and a mixture of humectants that includes glycerin. More preferably the humectant is glycerin. The humectant is added to the present invention at a level of 0.01 to about 25%. Preferably, the humectant is added at a level of about 10 to 25%. More preferably the humectant is added at a level of about 10% to about 15%.

In accordance with the present invention, the fat and humectant together will replace most of the water that would usually be in comparable products with traditional A_{w}. The total amount of fat plus humectant in the present invention will be in the range from about 20% to about 60% by weight of the finished product. Preferably the fat plus humectant comprises about 30% to about 40%, by weight, of the finished product.

The flavor agents of the present invention can be any desirable flavorant and chosen based on the desired flavor of the end product. The flavor agent may include natural flavorants, artificial flavorants, flavor enhancers, and combinations thereof. Flavor agents may be incorporated into the present invention at levels from about 0.05% to about 40% by weight. Some examples of flavorants include, but are not limited to cocoa, cocoa substitute, dutched cocoa, chocolate herbs, chocolate, caramel, caramel powder, maple syrup, hazelnut, almond, cashew, macadamia, pecan, walnut, and other nut flavor, marshmallow, vanilla, vanilla extract, imitation vanilla, nut, peanut butter, cream, cream cheese flavor, mint, spearmint, wintergreen, peppermint, creme de menthe, cinnamon, herbs, spices, oils, extracts, and the like and combinations thereof. The flavorant may further comprise up to about 20% of a dairy product selected from the group consisting of whey, whey protein concentrate, buttermilk powder, non-fat dry milk, milk powder, lactose, and combinations thereof. Other suitable dairy-based flavorants may be used as well.

When a fruit flavored low A_{w} food product is desired, fruit sources include, but are not limited to, fruit puree, fruit puree concentrate, fruit juice, fruit juice concentrate, fruit pieces, fruit concentrate, dried fruit, dehydrated fruit, fruit flakes, fruit powder, fruit extract, fruit flavored oils, artificial fruit, artificial fruit concentrate, and mixtures thereof. Examples of a few of the many specific fruits which can be utilized in the filling include, but are not limited to, berries of all types, currants, apricots, peaches, nectarines, plums, cherries, apples, pears, oranges, grapefruits, lemons, limes, tangerines, mandarins, tangelos, bananas, pineapples, grapes, tomatoes, rhubarbs, prunes, figs, pomegranates, passion fruit, guava, kiwi, kumquat, mangos, avocados, all types of melons, papaya, and combinations thereof. In one embodiment, dried fruit flakes are included in the low A_{w} food product. Fruit flakes contain little water, thus do not cause the water activity of the final low A_{w} food product to substantially increase. In one aspect of this embodiment, the fruit flakes are the primary source of fruit in the low A_{w} food product. In another aspect of this embodiment, fruit flakes are combined with one or more other fruit sources to provide the fruit content of the low A_{w} food product. In certain embodiments, the fruit content of the final low A_{w} food product constitutes up to 50% or more of the low A_{w} food product. In one aspect of this embodiment, the fruit content of the final low A_{w} food product constitutes up to about 40 weight percent of the low A_{w} food product. In another aspect of this embodiment, the fruit content of the final low A_{w} food product constitutes at least about 0.05 weight percent of the low A_{w} food product. In still another aspect of this embodiment, the fruit content of the final low A_{w} food product constitutes up to about 30 weight percent of the low A_{w} food product. In yet another aspect of this embodiment, the fruit content of the final low A_{w} food product constitutes about 0.1-30 weight percent of the low A_{w} food product. In a further aspect of this embodiment, the fruit content of the final low A_{w} food product constitutes about 1-25 weight percent of the low A_{w} food product. In still a further aspect of this embodiment, the fruit content of the final low A_{w} food product constitutes about 5-20 weight percent of the low A_{w} food product. In yet a further aspect of this embodiment, the fruit content of the final low A_{w} food product constitutes about 10-20 weight percent of the low A_{w} food product. In still yet a further aspect of this embodiment, the fruit content of the final low A_{w} food product constitutes about 12-20 weight percent of the low A_{w} food product.

In still yet another aspect of the invention, the low A_{w} food product includes a sweetener. The sweetener enhances the flavor of the final low A_{w} food product. The sweetener also modifies the fluidity of the low A_{w} food product during manufacture of the low A_{w} food product and after the final low A_{w} food product is formed. The sweeteners used in accordance with the present invention can be liquid sweeteners or solid sweeteners. The sweetener can include, but is not limited to, sucrose, dextrose, fructose, lactose, malt syrup, malt syrup solids, rice syrup, rice syrup solids, invert sugar, refiners syrup, corn syrup, corn syrup solids, maltodextrin, maltose, high fructose corn syrup, fructose syrup, honey, molasses, grain syrups, agave, and/or artificial sweeteners, including, but not limited to aspartame, sucralose, and saccharin and combinations thereof. In one embodiment, the sweetener includes syrup, honey, and/or molasses. The syrup, honey, and/or molasses add sweetness to the low A_{w} food product, add some water to the low A_{w} food product, and provide fluidity to the low A_{w} food product to enable other components of the low A_{w} food product to be mixed together during manufacture of the low A_{w} food product and/or facilitate in the pumping and/or extruding of the final low A_{w} food product into packaging and/or in the final food product. In another embodiment, the sweetener includes dried and/or powdered sweetener. The powdered and/or dried sweetener adds sweetness to the final low A_{w} food product; however, such sweetener adds little or no water to the low A_{w} food product, thus does not cause an increase in the water activity of the final low A_{w} food product. When a powdered and/or dry sweetener is used, it is preferred that the average particle size for dry sweetener is in the range of from about 25 to about 40 microns. In still another embodiment, non-powdered and/or non-dried sweetener and powdered and/or dried sweetener are added to the final low A_{w} food product. The sweetener of comprises about 0.01% to about 60% of the final product. Preferably, the sweetener comprises 0.01% to about 50% of the final product and more preferably the sweetener comprises about 30% to about 50% of the final product.

In a further aspect of the invention, the low A_{w} food product includes a starch. The starch is added as a thickening agent, a body forming agent to the low A_{w} food product, a stabilizer for the low A_{w} food product, and/or organoleptic characteristic enhancer of tie final low A_{w} food product. The starch content of the low A_{w} food product can be adjusted to dictate the consistency and texture of the low A_{w} food product. As with the addition of the sweetener to the low A_{w} food product, the addition of starch to the low A_{w} food product modifies the processability of the low A_{w} food product without the need to add significant amounts of water to the low A_{w} food product. The starch can include, but is not limited to, flours, natural or modified starches, corn, waxy corn, rice, wheat, tapioca, potato, arrowroot, maize, and/or oat. In one embodiment, an instant granular modified starch that is hydrateable by water into a highly viscose free standing mass is included in the low A_{w} food product. One type of instant granular modified starch that can be used in the low A_{w} food product is a modified corn starch sold under the trademark Mira-Thik by A.E. Staley Manufacturing Company. In another embodiment, an instant granular starch hydrateable by water to form a resilient, colloidal gel structure is included in the low A_{w} food product. One type of instant granular starch that can be used in the low A_{w} food product is a natural instant granular corn starch sold under the trademark Mira-Gel by A.E. Staley Manufacturing Company. In still another embodiment, the starch content of the final low A_{w} food product is up to about 15 weight percent. In one aspect of this embodiment, the starch content is about 0.01-15 weight percent of the final low A_{w} food product. In another aspect of this embodiment, the starch content is about 0.1-5 weight percent of the final low A_{w} food product. In yet another aspect of this embodiment, the starch content is about 0.1-4 weight percent of the final low A_{w} food product.

In still a further aspect of the invention, the filling includes an emulsifier. The emulsifier modifies and stabilizes the crystallization of the edible oil in the low A_{w} food product when the low A_{w} food product is cooled. The emulsifier also facilitates and stabilizes the oil and water phases within the low A_{w} product. The emulsifier also provides a smoother, more flowable consistency. The emulsifier includes, but is not limited to, lecithin, glycerol esters, diacetyl tartaric acids, esters of monoglycerides, mono- and di-glycerides, polyglycerol esters, polysorbate, propylene glycol esters, rice extract esters, sodium stearoyl-2-lactylate, sorbitan esters, sugar esters, and/or acetylated monoglycerides. Preferably the emulsifier is mono- and diglycerides. The emulsifier constitutes about 0.01-2 weight percent of the final low A_{w} food product. In a preferred embodiment, the emulsifier comprises from about 0.5% to about 1% of the final product.

In another aspect of the present invention, the water content of the final low A_{w} food product is sufficiently low so as to control the water activity of the final low A_{w} food product. In one embodiment of the invention, the water content of the final low A_{w} food product is less than about 25 weight percent. The water content of the food products of the present invention is preferably in the range from 0 to about 20% by weight. Preferably the water content in the final product will be about 1% to about 15% by weight, and even more preferably the water content will be about 1% to about 10% by weight. Water is generally added during the formation of the vegetable fat/glycerin emulsion. The water content in the inventive food product may come from the ingredients in the food product.

The water activity of the present invention is preferably less than about 0.85, more preferably less than about 0.8, even more preferably less than about 0.7, even more preferably less than about 0.6, even more preferably less than about 0.5, even more preferably less than about 0.45, even more preferably less than about 0.4, even more preferably less than about 0.35, and even more preferably less than about 0.3.

In some embodiments, the food product of the present invention comprises more than one phase. It is preferred that each of the phases has very similar A_{w} so in order to minimize reaction between the phases at the phase interface. The food product may be two phases, three phases, four phases, five phases, or more phases. The multi-phased food product may have no inclusions in any of the phases, or it may have inclusions in one or more of the phases. The multi-phase food product may have the same or different inclusions in different phases.

In another aspect of the current invention, the low A_{w} food product is combined with inclusions that have been coated with a barrier or film to further minimize or delay the migration of available water into the inclusion. Such a barrier or film enables the formulation of a higher water activity topping than preferred when using water activity alone as the primary mechanism to maintain inclusion crispiness over the shelf-life of the topping. In addition, formulating up to a higher water activity (i.e., 0.70) in conjunction with the use of moisture barrier technology will act to improve the sensory quality of the continuous phase in the eyes of consumers as being more similar to that of a traditionally processed ice cream topping. The composition of the moisture barrier can include but is not limited to beeswax alone or in combination with one or more of the following: whey protein (composed of α and β lactoglobulins), whey protein concentrate, zein, casein, soy protein, soy protein isolate, ovalbumin, serum albumin, seed protein (i.e., protein derived from oats, peanut, soybean, wheat, rapeseed, corn, sunflower), or protein derived from other natural sources. In still another aspect of the invention, the composition of the moisture barrier can include but is not limited to beeswax alone or in combination with one or more of the following: lecithin, glycerol esters, diacetyl tartaric acids, esters of mono and di-glycerides, mono and di-glycerides, polyglycerol esters, polysorbate, propylene glycol esters, sodium steroyl-2-lactylate, sorbitan esters, sugar esters, acetylated mono and di-glycerides, or emulsifiers derived from either natural or synthetic sources. Still further, the composition of the moisture barrier can include beeswax in various combinations with the protein and emulsifier sources previously mentioned. In one aspect of this embodiment, the moisture barrier layer or film can be applied to the inclusion either by spraying or dipping with the water barrier properties being strictly dependent upon the composition of the layer or film itself and also the thickness of the applied layer or film.

The present invention further comprises a method of making the low A_{w} food product. The method comprises first adding the glycerin, water, and liquid sweeteners and mixing. Next, the lipid-based components are mixed together and heated until melted. The melted lipid-based products are then slowly added to the glycerin mixture. After the lipids are added to the glycerin mixture, the remaining solid ingredients are added and mixed. If necessary, the mixture may be cooled before packaging. A preferred temperature range for packaging the low A_{w} food product is from about 60° F. to about 130° F., more preferably from about 70° F. to about 120° F., and even more preferably from about 80° F. to about 110° F. A preferred method for lowering the temperature of the low A_{w} food product is to use a scrape surface heat exchanger. When inclusions are desired in the low A_{w} food product, they may be added just prior to filling and sealing of the low A_{w} food product. When a multiphase product is desired, a pressure-fed filling head with segmented nozzle ports can be used to introduce the multiple phases to the fill container. In this way, multi-phased, striped low A_{w} food products can be made.

### BRIEF DESCRIPTION OF THE DRAWINGS

Reference may now be made to the drawings, which illustrate various embodiments that the invention may take in physical form and in certain parts and arrangements of parts wherein:

FIG. 1 is flow diagram for production of low water activity, cold process caramel and chocolate ice cream toppings;

FIG. 2 is a flow diagram detailing a process for the manufacture of a two-phase product;

FIG. 3 is a flow diagram detailing a conventional process for making ice cream toppings that do not have low A_{w}

FIG. 4 is a perspective view of an edible oil crystal;

FIG. 4A is a perspective view of a fractured edible oil crystal as shown in FIG. 3;

FIG. 5 illustrates a globule of final low A_{w} food product filling in accordance with the present invention, wherein fractured edible oil crystals are dispersed with various other components of the filling;

FIG. 6 is a side sectional view of a filled food product containing the final filling;

FIG. 7 is a flow chart detailing a continuous process for the manufacturing of the filling;

FIG. 8 is a graphical illustration of the water activity of the filling during the continuous process manufacturing of the filling as illustrated in FIG. 6;

FIG. 9 is an elevation view of a scraped surface heat exchanger;

FIG. 10 is a graphical illustration of the crystal size of the one or more edible oils in the filling as a function of the final processing temperature of the filling;

FIG. 11 is a graphical illustration of the texture of the filling as a function of the final processing temperature of the filling;

FIG. 12 is a flow chart detailing a batch process for the manufacturing of the filling; and

FIG. 13 is a graphical illustration of the water activity of the filling during the batch process manufacturing of the filling as illustrated in FIG. 9.

FIG. 14 compares the Rheology for Low A_{w} chocolate and caramel ice cream toppings, regular hot fudge ice cream topping, and a Low A_{w} strawberry filling.

### DETAILED DESCRIPTION OF THE INVENTION

The low A_{w} food products of the present invention have many advantages over conventional toppings, sauces, fillings, icings, etc., in that they are able to maintain the crispness/crunchiness of low-moisture inclusions, such as pie crust, cookies, cake pieces, crumbs, marshmallows (dehydrated), crackers, nuts, roasted or otherwise, candy (confections, hard candies), cereals (crisped rice, flaked corn, corn pops), chocolate chunks, panned or molded chocolate candy, malted milk balls, M&M's®, SNICKERS®, MILKY WAY®, BUTTERFINGER®, and the like. The low A_{w} food product of the present invention also allows for the production of multi-phased products that include peanut butter or other inherently low A_{w} food materials as one or more of the phases. The low A_{w} food products of the present invention possess the textural and function attributes, such as microwavability, of higher A_{w} food products. The low A_{w} food product of the present invention is also microwavable, and able to maintain desirable flavor, mouthfeel, and texture when heated. The low A_{w} food products of the present invention are also microbiologically stable, because of their low A_{w}, and thus, do not require refrigeration either before or after opening the product. Additionally, the low A_{w} food products of the present invention can easily be adapted from sweet, dessert-type toppings, like chocolate, caramel, chocolate/caramel, chocolate/caramel/peanut, and hot fudge ice cream toppings, to fruit toppings, to icings, to fillings for pastries, doughnuts, to savory fillings for crackers, to savory types of sauces, like cheese sauces, to dipping sauces, like cheese dips.

The low A_{w} food products of the present invention are also much easier and less costly to prepare than conventional ice cream toppings, sauces, and fillings. The low A_{w} food products made according to the methods of the present invention require a low capital start-up investment. The inventive process for preparing the low A_{w} food products eliminates the need for heating, cooking, vacuuming, homogenizing and pasteurizing the ice cream topping, which is a significant saving of time, energy and other resources. Utilizing the new preparation process, the low A_{w} food products of the present invention can be filled into retail containers at very low fill temperatures (i.e. less than about 120° F.) without compromising microbial stability. The low A_{w} food products of the present invention can also open the door for many different SKUs for multiphase products, such as chocolate/caramel, marshmallow/chocolate, or any other combination of low A_{w} food products of the present invention, and combinations of the low A_{w} food products combined with other food products, where a variety of low-moisture inclusions can be used. Examples of possible inclusions include M&M Mars® candies, Heath® bar pieces, granola, Oreo® cookie pieces, and various nut meats, to name only a few. The inventive method and the formulation technology for the inventive low A_{w} food products can be easily adapted to flavors ranging from chocolate to strawberry. Additionally, the present invention provides methods for making multi-phase sauces, spreads, and the like, wherein different phases to be produced separately in bulk containers and stored for later use. The present invention also provides a method of preparing a low A_{w} food product that can be produced as part of a continuous process in which it is incorporated immediately into the final retail container.

The low A_{w} food product of the present invention comprises about 0.05% to about 40% by weight flavor agent; about 0.01% to about 30% by weight of a liquid oil; about 0.01% to about 5% of a high melting point oil; about 0.01% to about 25% by weight humectant; about 0.01% to about 50% by weight sweetener; about 0.01% to about 2% by weight emulsifier; and a water activity of less than about 0.85. In another aspect, the present invention further comprises inclusions. The inclusions can be added to the low A_{w} ice cream topping at levels of up to 40% by weight. Preferably the inclusions are added at about 10% to about 40% by weight. More preferably, the inclusions are added at about 20% to about 25% by weight. The inclusions can be virtually any low A_{w} additive that is desirable in the low A_{w} food composition. In one embodiment, the low A_{w} inclusions are added to the topping without applying any coating to the inclusions. Some exemplary inclusions are crumbs, pie crust, cookies, cake pieces, brownie pieces, dehydrated marshmallows, crackers, nuts, nut meats, roasted nuts, seeds, oats, candies, confections, chocolates, hard candies, gum, chocolate chunks, chocolate chips, panned or molded chocolate candy, malted milk balls, M&M's®, candy bar bits, such as SNICKERS® bits, MILKY WAY® bits, BUTTERFINGER® bits, and the like.

In another aspect of the current invention, the low A_{w} food product is combined with inclusions that have been coated with a barrier or film to further minimize or delay the migration of available water into the inclusion. Such a barrier or film enables the formulation of a higher water activity topping than preferred when using water activity alone as the primary mechanism to maintain inclusion crispiness over the shelf-life of the topping. In addition, formulating up to a higher water activity (i.e., 0.70) in conjunction with the use of moisture barrier technology will act to improve the sensory quality of the continuous phase in the eyes of consumers as being more similar to that of a traditionally processed ice cream topping. The composition of the moisture barrier can include but is not limited to beeswax alone or in combination with one or more of the following: whey protein (composed of α and β lactoglobulins), whey protein concentrate, zein, casein, soy protein, soy protein isolate, ovalbumin, serum albumin, seed protein (i.e., protein derived from oats, peanut, soybean, wheat, rapeseed, corn, sunflower), or protein derived from other natural sources. In still another aspect of the invention, the composition of the moisture barrier can include but is not limited to beeswax alone or in combination with one or more of the following: lecithin, glycerol esters, diacetyl tartaric acids, esters of mono and di-glycerides, mono and di-glycerides, polyglycerol esters, polysorbate, propylene glycol esters, sodium steroyl-2-lactylate, sorbitan esters, sugar esters, acetylated mono and di-glycerides, or emulsifiers derived from either natural or synthetic sources. Still further, the composition of the moisture barrier can include beeswax in various combinations with the protein and emulsifier sources previously mentioned. In one aspect of this embodiment, the moisture barrier layer or film can be applied to the inclusion either by spraying or dipping with the water barrier properties being strictly dependent upon the composition of the layer or film itself and also the thickness of the applied layer or film.

In another aspect of the invention, the low A_{w} food product includes a combination of edible oil and humectant to achieve the low water activity of the low A_{w} food product. The edible oil and the humectant are, in one sense, used as a partial or full substitute for water in the low A_{w} food product, thus enabling the low A_{w} food product to be formulated with a low water activity. The edible oil and humectant also function to fluidize and plasticize the low A_{w} food product thereby facilitating in dispersing other components of the low A_{w} food product when added to low A_{w} food product during the manufacturing of the low A_{w} food product. The edible oil and humectant further facilitate in the low A_{w} food product being easily processed (i.e. pumped, stirred, mixed, extruded, etc.) during the manufacturing of the low A_{w} food product. The high melt point oil also functions as a high temperature stabilizing agent for the low A_{w} food product when the final, low A_{w} food product is exposed to temperatures above ambient temperature, such as when microwaved. The humectant also functions to bind the components of the low A_{w} food product together.

The fat, shortening, or oil of the present invention can be virtually any edible fat or oil, and the words “fat” and “oil” are used interchangeably herein. While the word “fat” or “shortening” often refer to fats that are solid at room temperature, as used herein, the word “oil” encompasses both hydrogenated oils that are semisolid or solid at room temperature as well as oils that are liquid at room temperature, often referred to as “oils.” The term “oil” as used herein further encompasses all edible fats, including animal fats, vegetable fats, seed fats. For convenience, all fats, whether animal or plant based, solid, liquid, shortening, combinations thereof, and so forth, will simply be referred to as “oils.” The oils used in the present invention can be natural, partially hydrogenated, hydrogenated, or a combination thereof. Some preferred vegetable fats include: soybean, cottonseed, canola, rapeseed, peanut, safflower, sunflower, coconut, palm, palm kernel, olive, butterfat, cocoa butter, tallow, lard, corn, and combinations thereof. Preferably the oil is a vegetable oil. The low A_{w} ice cream toppings of the present invention use a combination of two or more oils to achieve the desired fluidity and stability. The low A_{w} ice cream toppings comprise about 0.01-30% of a liquid oil, which may be emulsified or unemulsified, partially hydrogenated or unhydrogenated, preserved (with TBHQ, BHT or other preservative), or unpreserved, seed, nut, and/or grain oils, such as cottonseed, palm kernal, peanut, wheat, etc. A preferred liquid oil is a partially hydrogenated liquid oil sold under the name Durkex 500, manufactured by Loders-Croklaan, 24708 W. Durkee Rd., Channabon Ill. 60410-5249. The low A_{w} ice cream toppings also comprise a second oil at a level of about 0.01% to 5% by weight. The second oil is a high melting point oil with a melting point in the range from about 95° F. to about 155° F. While a two oil system, i.e. comprising a liquid oil and a high melting point oil is preferred, a single oil system may also be used in accordance with the present invention.

In accordance with the present invention, other fats or combinations of fats may be used depending on the desired properties of the final product. The food product of the present invention can comprise up to about 35% fat. Preferably the low A_{w} ice cream toppings of the present invention comprise about 5% to about 30% fat.

The humectant of the present invention is selected from the group consisting of glycerin, 1,3-butyl glycol, mannitol, sorbitol, fructose, propylene glycol, and combinations thereof. Preferably, the humectant is selected from glycerin and a mixture of humectants that includes glycerin. More preferably the humectant is glycerin. The humectant is added to the present invention at a level of 0.01 to about 25%. In accordance with the present invention, the fat and humectant together will replace most of the water that would usually be in comparable ice cream toppings or other prducts with traditional A_{w}.

The flavor agents of the present invention can be any desirable flavorant and chosen based on the desired flavor of the end product. The flavor agent may include natural flavorants, artificial flavorants, flavor enhancers, and combinations thereof. Flavor agents may be incorporated into the present invention at levels from about 0.05% to about 40% by weight. Some examples of flavorants include, but are not limited to cocoa, cocoa substitute, dutched cocoa, chocolate herbs, chocolate, caramel, caramel powder, maple syrup, hazelnut, almond, cashew, macadamia, pecan, walnut, and other nut flavor, marshmallow, vanilla, vanilla extract, imitation vanilla, nut, peanut butter, cream, cream cheese flavor, mint, spearmint, wintergreen, peppermint, creme de menthe, cinnamon, herbs, spices, oils, extracts. The flavorant may further comprise from 0 to about 20% of a dairy product selected from the group consisting of whey, whey protein concentrate, buttermilk powder, non-fat dry milk, milk powder, lactose, and combinations thereof. Other dairy-based flavorants may be used as well. When the low A_{w} food product is something other than an ice cream topping, the flavorant may also include vegetable puree, vegetable puree concentrate, vegetable juice, vegetable juice concentrate, vegetable flakes, vegetable powder, artificial vegetable, artificial vegetable concentrate, dried vegetable, vegetable extract, spice extract, herb extract, flavored oils, cheese, and the like and combinations thereof.

When a fruit flavored low A_{w} ice cream topping or other food product is desired, fruit sources include, but are not limited to, fruit puree, fruit puree concentrate, fruit juice, fruit juice concentrate, fruit pieces, fruit concentrate, dried fruit, dehydrated fruit, fruit flakes, fruit powder, fruit extract, fruit flavored oils, artificial fruit, artificial fruit concentrate, and mixtures thereof. Examples of a few of the many specific fruits which can be utilized in the filling include, but are not limited to, berries of all types, currants, apricots, peaches, nectarines, plums, cherries, apples, pears, oranges, grapefruits, lemons, limes, tangerines, mandarins, tangelos, bananas, pineapples, grapes, tomatoes, rhubarbs, prunes, figs, pomegranates, passion fruit, guava, kiwi, kumquat, mangos, avocados, all types of melons, and/or papaya. In one embodiment, dried fruit flakes are included in the low A_{w} food product. Fruit flakes contain little; water, thus do not cause the water activity of the final low A_{w} food product to substantially increase. In one aspect of this embodiment, the fruit flakes are the primary source of fruit in the low A_{w} food product. In another aspect of this embodiment, fruit flakes are combined with one or more fruit sources to provide the fruit content of the low A_{w} food product. In another embodiment, the fruit content of the final low A_{w} food product constitutes up to a majority of the low A_{w} food product. In one aspect of this embodiment, the fruit content of the final low A_{w} food product constitutes up to about 40 weight percent of the low A_{w} food product. In another aspect of this embodiment, the fruit content of the final low A_{w} food product constitutes at least about 0.05 weight percent of the low A_{w} food product. In still another aspect of this embodiment, the fruit content of the final low A_{w} food product constitutes up to about 30 weight percent of the low A_{w} food product. In yet another aspect of this embodiment, the fruit content of the final low A_{w} food product constitutes about 0.1-30 weight percent of the low A_{w} food product. In a further aspect of this embodiment, the fruit content of the final low A_{w} food product constitutes about 1-25 weight percent of the low A_{w} food product. In still a further aspect of this embodiment, the fruit content of the final low A_{w} food product constitutes about 5-20 weight percent of the low A_{w} food product. In yet a further aspect of this embodiment, the fruit content of the final low A_{w} food product constitutes about 10-20 weight percent of the low A_{w} food product. In still yet a further aspect of this embodiment, the fruit content of the final low A_{w} food product constitutes about 12-20 weight percent of the low A_{w} food product.

In still yet another aspect of the invention, the low A_{w} food product includes a sweetener. The sweetener enhances the flavor of the final low A_{w} food product. The sweetener also modifies the fluidity of the low A_{w} food product during manufacture of the low A_{w} food product and after the final low A_{w} food product is formed. The sweeteners used in accordance with the present invention can be liquid sweeteners or solid sweeteners, and combinations thereof, and is added at levels from about 0.01% to about 50% by weight. The sweetener can include, but is not limited to, sucrose, dextrose, fructose, lactose, malt syrup, malt syrup solids, rice syrup, rice syrup solids, invert sugar, refiners syrup, corn syrup, corn syrup solids, maltose, high fructose corn syrup, fructose syrup, honey, molasses, grain syrups, agave, and/or artificial sweeteners, including, but not limited to aspartame, sucralose, and saccharin and combinations thereof. In one embodiment, the sweetener includes syrup, honey, and/or molasses. The syrup, honey, and/or molasses add sweetness to the low A_{w} food product, add some water to the low A_{w} food product, and provide fluidity to the low A_{w} food product to enable other components of the low A_{w} food product to be mixed together during manufacture of the low A_{w} food product and/or facilitate in the pumping and/or extruding of the final low A_{w} food product into packaging and/or in the final food product.

In another embodiment, the sweetener includes dried and/or powdered sweetener. The powdered and/or dried sweetener adds sweetness to the final low A_{w} food product; however, such sweetener adds little or no water to the low A_{w} food product, thus does not cause an increase in the water activity of the final low A_{w} food product. When a powdered and/or dry sweetener is used, it is preferred that the average particle size for dry sweetener is in the range of from about 25 to about 40 microns. In still another embodiment, non-powdered and/or non-dried sweetener and powdered and/or dried sweetener are added to the final low A_{w} food product. The sweetener constitutes up to about 50 weight percent of the final low A_{w} ice cream topping. In other low A_{w} food products, the sweetener can comprise up to 80% by weight of the final product. In still another aspect of this embodiment, the sweetener constitutes about 10-50 weight percent of the final low A_{w} food product. In still yet another aspect of this embodiment, the sweetener constitutes about 30-50 weight percent of the final low A_{w} food product. In still a further aspect of this embodiment, the sweetener constitutes about 30-45 weight percent of the final low A_{w} food product.

In a further aspect of the invention, the low A_{w} food product includes a starch. The starch is added as a thickening agent, a body forming agent to the low A_{w} food product, a stabilizer for the low A_{w} food product, and/or organoleptic characteristic enhancer of the final low A_{w} food product. The starch content of the low A_{w} food product can be adjusted to dictate the consistency and texture of the low A_{w} food product. As with the addition of the sweetener to the low A_{w} food product, the addition of starch to the low A_{w} food product modifies the processability of the low A_{w} food product without the need to add significant amounts of water to the low A_{w} food product. The starch can include, but is not limited to, flours, natural or modified starches, corn, waxy corn, rice, wheat, tapioca, potato, arrowroot, maize, and/or oat. In one embodiment, an instant granular modified starch that is hydrateable by water into a highly viscose free standing mass is included in the low A_{w} food product. One type of instant granular modified starch that can be used in the low A_{w} food product is a modified corn starch sold under the trademark Mira-Thik by A.E. Staley Manufacturing Company. In another embodiment, an instant granular starch hydrateable by water to form a resilient, colloidal gel structure is included in the low A_{w} food product. One type of instant granular starch that can be used in the low A_{w} food product is a natural instant granular corn starch sold under the trademark Mira-Gel by A.E. Staley Manufacturing Company. In still another embodiment, the starch content of the final low A_{w} food product is up to about 15 weight percent. In one aspect of this embodiment, the starch content is about 0.01-15 weight percent of the final low A_{w} food product. In another aspect of this embodiment, the starch content is about 0.1-5 weight percent of the final low A_{w} food product. In yet another aspect of this embodiment, the starch content is about 0.1-4 weight percent of the final low A_{w} food product.

In still a further aspect of the invention, the filing includes an emulsifier. The emulsifier modifies and stabilizes he crystallization of the edible oil in the low A_{w} food product when the low A_{w} food product is cooled. The emulsifier also stabilizes the oil and water phases within the low A_{w} product. The emulsifier also provides a smoother, more flowable consistency. The emulsifier includes, but is not limited to, lecithin, glycerol esters, diacetyl tartaric acids, esters of monoglycerides, unmodified mono- and diglycerides, mono- and diglyceride blends, polyglycerol esters, polysorbate, propylene glycol esters, rice extract esters, sodium stearoyl-2-lactylate, sorbitan esters, sugar esters, and/or acetylated monoglycerides. Preferably the emulsifier is mono- and diglycerides. A preferred emulsifier is sold under the trade name PANODAN®. In one embodiment, the emulsifier content of the final low A_{w} food product is up to about 10% by weight. In one aspect of this embodiment, the emulsifier constitutes up to about 5 weight percent of the final low A_{w} food product. In another aspect of this embodiment, the emulsifier constitutes about 0.01-5 weight percent of the final low A_{w} food product. For low A_{w} ice cream toppings, the emulsifier is preferably added at a level of 0.01-2% by weight percent of the final low A_{w} food product.

In still yet a further aspect of the invention, the low A_{w} food product includes one or more additional components to alter the flavor, color, shelf life, and/or organoleptic characteristics of the low A_{w} food product. The additional components include, but are not limited to, natural and/or artificial flavorings, acidulants, coloring agents, stabilizers, salt, antimicrobial preservatives, vitamins, minerals, and/or antioxidant preservatives. One or more of these additional components are used to increase the shelf life of the low A_{w} food product, improve the nutritional value of the low A_{w} food product, improve the taste of the low A_{w} food product, alter and/or improve the appearance of the low A_{w} food product, and/or improve one or more organoleptic characteristics of the low A_{w} food product. When natural and/or artificial flavorings are included in the low A_{w} food product, the natural and/or artificial flavorings include artificial fruit, artificial fruit concentrate, natural fruit, natural fruit concentrate, artificial vegetable, artificial vegetable concentrate, natural vegetable, natural vegetable concentrate, fruit extract, vegetable extract, cocoa, caramel, caramel powder, maple syrup, spices, herbs, and/or flavored oils. As can be appreciated, other natural and/or artificial flavorings can be alternatively or additionally used in the low A_{w} food product. When natural fruit and/or natural fruit concentrate are used as a flavoring agent, the weight percentage of the natural fruit and/or natural fruit concentrate is included in the weight percentage of the fruit used in the low A_{w} food product. Similarly, when natural vegetable and/or natural vegetable concentrate are used as a flavoring agent, the weight percentage of the natural vegetable and/or natural vegetable concentrate is included in the weight percentage of the vegetable used in the low A_{w} food product. In one embodiment, the natural and/or artificial flavoring, when added to the low A_{w} food product, constitutes at least about 0.01 weight percent of the final low A_{w} food product. In one aspect of this embodiment, the natural and/or artificial flavoring constitutes up to about 30 weight percent of the final low A_{w} food product. In another aspect of this embodiment, the natural and/or artificial flavoring constitutes up to about 20 weight percent of the final low A_{w} food product. In yet another aspect of this embodiment, the natural and/or artificial flavoring constitutes about 0.01-20 weight percent of the final low A_{w} food product. In still another aspect of this embodiment, the natural and/or artificial flavoring constitutes about 0.01-20 weight percent of the final low A_{w} food product. In still yet another aspect of this embodiment, the natural and/or artificial flavoring constitutes about 0.01-5 weight percent of the final low A_{w} food product. In a further aspect of this embodiment, the natural and/or artificial flavoring constitutes about 0.1-2 weight percent of the final low A_{w} food product.

When one or more acidulants are included in the low A_{w} food product, the acidulant generally includes citric acid, malic acid, tartaric acid, lactic acid, acetic acid, phosphoric acid, adipic acid, glucono delta lactone acid, fumaric acid, succinic acid, tannic acid, folic acid, ascorbic acid, and/or pantothenic acid. As can be appreciated other acidulants can be alternatively or additionally used in the low A_{w} food product. In one embodiment, the acidulant, when added to the low A_{w} food product, constitutes at least about 0.01 weight percent of the final low A_{w} food product. In one aspect of this embodiment, the acidulant constitutes up to about 10 weight percent of the final low A_{w} food product. In another aspect of this embodiment, the acidulant constitutes up to about 5 weight percent of the final low A_{w} food product. In yet another aspect of this embodiment, the acidulant constitutes about 0.01-5 weight percent of the final low A_{w} food product. In still another aspect of this embodiment, the acidulant constitutes about 0.05-5 weight percent of the final low A_{w} food product. In still yet another aspect of this embodiment, the acidulant constitutes about 0.1-1.5 weight percent of the final low A_{w} food product. In a further aspect of this embodiment, the acidulant constitutes about 0.1-1 weight percent of the final low A_{w} food product.

When one or more coloring agents are included in the low A_{w} food product, coloring agents generally includes natural and/or artificial coloring agents. The coloring agents include coal tar dyes, aluminum lake insoluble coal tar dyes, concentrated or dry forms of grape skin extracts, titanium oxide, grape concentrate, purple carrot concentrate, fruit extracts, fruit juice concentrates, vegetable extracts, vegetable juice concentrates, beet, carmine, cochineal extracts, annatto, paprika, tumeric, beta carotene, purple potato, and/or radish. As can be appreciated other coloring agents can be alternatively or additionally used in the low A_{w} food product. In one embodiment, the coloring agent, when added to the low A_{w} food product, constitutes at least about 0.005 weight percent of the final low A_{w} food product. In one aspect of this embodiment, the coloring agent constitutes up to about 5 weight percent of the final low A_{w} food product. In another aspect of this embodiment, the coloring agent constitutes up to about 2 weight percent of the final low A_{w} food product. In yet another aspect of this embodiment, the coloring agent constitutes about 0.01-1 weight percent of the final low A_{w} food product.

While a water activity of about 0.7 or less is generally microbiologically stable, if the low A_{w} food product is in risk of being subjected to water, antimicrobial preservatives can be added to control microbiological growth. When one or more antimicrobial preservatives are included in the low A_{w} food product, antimicrobial preservatives generally include sodium benzoate and potassium sorbate. As can be appreciated other antimicrobial preservatives can be alternatively or additionally used in the low A_{w} food product. In one embodiment, the antimicrobial preservative, when added to the low A_{w} food product, constitutes up to about 2 weight percent of the final low A_{w} food product. In one aspect of this embodiment, the antimicrobial preservative constitutes up to about 0.5 weight percent of the final low A_{w} food product. In another aspect of this embodiment, the antimicrobial preservative, constitutes at least about 0.005 weight percent of the final low A_{w} food product.

When one or more vitamins and/or minerals are included in the low A_{w} food product, vitamins and/or minerals generally include ascorbic acid, beta carotene, biotin, calcium pantothenate, choline, folic acid, niacin, vitamin A, vitamin B₁, vitamin B₂, vitamin B₆, vitamin B₁₂, vitamin D₂, vitamin D₃, niacinamide, vitamin E, vitamin K, boron, calcium, chromium, copper, iodine, iron, magnesium, molybdenum, nickel, potassium, selenium, vanadium, and/or zinc. As can be appreciated other vitamins and minerals can be alternatively or additionally used in the low A_{w} A_{w} food product. In one embodiment, the vitamin and/or mineral preservatives, when added to the low A_{w} food product, constitute up to about 5 weight percent of the final low A_{w} food product. In one aspect of this embodiment, the vitamins and/or minerals constitute up to about 2 weight percent of the final low A_{w} food product. In another aspect of this embodiment, the vitamins and/or minerals constitute at least about 0.1 weight percent of the final low A_{w} food product.

When one or more salts are included in the low A_{w} food product, salt generally includes sodium chloride, potassium chloride, calcium chloride and mixtures thereof. As can be appreciated, other edible salts can be alternatively or additionally used in the low A_{w} food product. In one embodiment, the salt, when added to the low A_{w} food product, constitutes up to about 2 weight percent of the final low A_{w} food product. In one aspect of this embodiment, the salt constitutes up to about 1 weight percent of the final low A_{w} food product. In another aspect of this embodiment, the salt constitutes at least about 0.05 weight percent of the final low A_{w} food product.

When one or more stabilizers are included in the low A_{w} food product, the stabilizer generally includes cellulose, cellulose gel, cellulose gum, pectin, seaweed, xanthan gum, carrageenan, an alginate, cellulose gums, modified starches, gelatin and/or maltodextrins. The cellulose, cellulose gel, cellulose gum, and xanthin gum are chosen from, but are not limited to, pectin, guar, locust bean, tara, gellan, alginate, tragacanth, karcaya, Ghatti, agar, seaweed, gelatin, arabic, acacia, carrageenan, carboxmethylcellulose, and/or hydropropylmethocellulose gum. As can be appreciated, other stabilizers can be alternatively or additionally used in the low A_{w} food product. In one embodiment, the stabilizer, when added to the low A_{w} food product, constitutes up to about 2 weight percent of the final low A_{w} food product. In one aspect of this embodiment, the stabilizer constitutes up to about 1 weight percent of the final low A_{w} food product. In another aspect of this embodiment, the stabilizer constitutes at least about 0.01 weight percent of the final low A_{w} food product.

When antioxidant preservatives are included in the low A_{w} food product, antioxidant preservatives generally include BHA, BHT and/or TBHQ. As can be appreciated, other antioxidant preservatives can be alternatively or additionally used in the low A_{w} food product. The antioxidant preservatives can be added to increase shelf life of the low A_{w} food product. In one embodiment, the antioxidant preservative, when added to the low A_{w} food product; constitutes at least about 0.001 weight percent of the final low A_{w} food product. In one aspect of this embodiment, the antioxidant preservative constitutes up to about 2 weight percent of the final low A_{w} food product. In another aspect of this embodiment, the antioxidant preservative constitutes up to about 0.01-1 weight percent of the final low A_{w} food product. In still another aspect of this embodiment, the antioxidant preservative constitutes up to about 0.01-0.5 weight percent of the final low A_{w} food product.

In another aspect of the present invention, the water content of the final low A_{w} food product is sufficiently low so as to control the water activity of the final low A_{w} food product. In one embodiment of the invention, the water content of the final low A_{w} food product is less than about 25 weight percent. The water content of the food products of the present invention is preferably in the range from 0 to about 20% by weight. Preferably the water content in the final product will be about 1% to about 15% by weight, and more preferably the water content will be about 1% to about 10% by weight. Water is generally added during the formation of the vegetable fat/glycerin emulsion. The water content in the inventive food product may come from the ingredients in the food product.

The water activity of the present invention is preferably less than about 0.85, more preferably less than about 0.8, even more preferably less than about 0.7, even more preferably less than about 0.6, even more preferably less than about 0.5, even more preferably less than about 0.45, even more preferably less than about 0.4, even more preferably less than about 0.35, even more preferably less than about 0.3, and even more preferably less than about 0.25.

In some embodiments, the food product of the present invention comprises more than one phase. It is preferred that each of the phases has very similar A_{w} so in order to minimize reaction between the phases at the phase interface. Preferably the water activities of the different phases will be within less than 0.3 A_{w} units of each other. More preferably, the water activities of the different phases will be within less than 0.2 A_{w} units of each other. Even more preferably, the water activities will be within less than 0.1 A_{w} units of each other. The food product may be two phases, three phases, four phases, five phases, or more phases. The multi-phased food product may have no inclusions in any of the phases, or it may have inclusions in one or more of the phases. The multi-phase food product may have the same or different inclusions in different phases.

The present invention further comprises a method of making the low A_{w} food product. The method comprises first adding the glycerin, water, and liquid sweeteners and mixing. Next, the lipid-based components are mixed together and heated until all are melted. The melted lipid-based products are then slowly added to the glycerin mixture. After the lipids are added to the glycerin mixture, the remaining solid ingredients are added and mixed. The finished product is then filled into containers. When inclusions are desired in the low A_{w} food product, they may be added just prior to filling and sealing of the low A_{w} food product. When a multiphase product is desired, a pressure-fed filling head with segmented nozzle ports can be used to introduce the multiple phases to the fill container. In this way, multi-phased, striped low A_{w} food products can be made.

Referring now to the drawings, wherein the showings are for the purpose of illustrating the preferred embodiments of the invention only, and not for the purpose of limiting the same, the present invention relates generally to a low A_{w} food product which can be a topping, such as an ice cream topping, a dessert sauce, a savory sauce, a dessert spread, a bread spread or sandwich spread, a confectionary filling, a confection topping, an icing, a filling inserted onto or into a food product, or similar. Preferably, the Low A_{w} food product is an ice cream topping. Typical ice cream topping flavors include chocolate toppings, caramel toppings and fillings, butterscotch toppings, fudge toppings, fruit sauces, marshmallow toppings, nougat toppings and fillings, fruit fillings, marshmallow fillings, fruit flavored fillings, and the like. The invention further relates to sauces, toppings, fillings, icings, and the like having inclusions, such as nuts, crumbs, candies, chocolates, candy bar bits, hard candies, dehydrated marshmallows, and so forth.

A general formula for the low A_{w} food product compositions of the present invention is:

| Ingredient | Percent By Weight |
|---|---|
| Flavor Agent | about 0.05-40% |
| Humectant | about 0.01-25% |
| Sweetener | about 0.01-50% |
| Liquid Oil | about 0.01-30% |
| High melting point Oil | about 0.01-5% |
| Emulsifier | about 0.01-2% |

and a more specific formulation for a low A_{w} ice cream toppings are set forth in examples 1 and 2.

### EXAMPLE 1

### Low A_{w} Caramel Ice Cream Topping

| Ingredient | % | Solids |
|---|---|---|
| Maltodextrin (Maltrin M-100) | 4.7 | 4.4415 |
| Glycerin | 10 | 9.95 |
| Liquid Oil (Durkex 500) | 26 | 26 |
| Krystar-Liquid Syrup-77 Brix | 39 | 30.03 |
| Krystar Powdered Fructose (Staley) | 8 | 8 |
| Mira-Thik 468 DF | 2.67 | 2.5365 |
| Mira-Gel 463 DF | 1.33 | 1.2635 |
| Dritex C | 0.5 | 0.5 |
| Flay-Caramel-Koshered #33 | 0.8 | 0.568 |
| Caramel Coloring-Sethness-OZ AP-100 | 0.37 | 0.2405 |
| Caramel Coloring-Sethness-OZ AP-100 | 0.014 | 0.0091 |
| Extra Fine 200 Salt (Morton) | 0.35 | 0.35 |
| Panodan 150 K | 1 | 1 |
| NF Dry Milk-Low Spore/Low Heat | 4.5 | 4.5 |
| Vanillin | 0.1 | 0.1 |
| Wixon Liquid Sweetaway | 0.1 | 0.1 |
| Water | 0.566 | 0 |
| Total | 100 | 89.589 |

Preparation is as follows: 1) Combine glycerin, wixon, liquid krystar, and water in a Liquiverter. Adjust speed to minimize air incorporation. Mix 10 minutes. 2) Combine a portion of the oil with Dritex and Panodan. Heat to 140-150° F. in a steam jacketed kettle. Slowly add heated oil mixture followed by remaining oil to glycerin mixture. 3) Add Krystar powder, salt, flavors, flavors, and non-fat dry milk. 4) Add starches and maltodextrin. 5) Pass through shear pump and fill into containers.

### EXAMPLE 2

### Low A_{w} Chocolate Ice Cream Topping

| Ingredient | % | Solids |
|---|---|---|
| Star-Dri 100 (Staley) | 2 | 2 |
| Glycerin | 10 | 9.95 |
| Liquid Oil (Durkex 500) | 25 | 25 |
| Krystar-Liquid Syrup-77 Brix | 40 | 30.8 |
| Krystar Powdered Fructose (Staley) | 8 | 8 |
| Dritex C | 0.5 | 0.5 |
| Chocolate Liquor - Natural | 1.2 | 1.2 |
| Cocoa Nat 11-N-003 Low Micro (ADM) | 3.5 | 3.5 |
| Vanillin | 0.04 | 0.04 |
| Extra Fine 200 Salt (Morton) | 0.3 | 0.3 |
| NF Dry Milk-Low Spore/Low Heat | 4 | 4 |
| Wixon Liquid Magnifique | 0.1 | 0.0006 |
| Panodan 150 K | 1 | 1 |
| Mira-Thik 468 DF | 2.67 | 2.5365 |
| Mira-Gel 463 DF | 1.33 | 1.2635 |
| Water | 0.36 | 0 |
| Total | 100 | 90.091 |

Preparation is as follows: 1) Combine glycerin, wixon, liquid krystar, and water in a Liquiverter. Adjust speed to minimize air incorporation. Mix 10 minutes. 2) Combine a portion of the oil with Dritex, chocolate liquor, and Panodan. Heat to 140-150° F. in a steam jacketed kettle. Slowly add heated oil mixture followed by remaining oil to glycerin mixture. 3) Add Krystar powder, salt, flavors, and non-fat dry milk. 4) Add starches and cocoa powder. 5) Pass through shear pump and fill into containers.

### EXAMPLE 3

### Comparative Example—Typical Hot Fudge Topping Formula

Product Solids 72.0%

| Ingredient | % |
|---|---|
| Corn Syrup Solids | 33.00 |
| Water | 27.69 |
| Sugar | 12.00 |
| Hydrogenated Vegetable Oil | 11.00 |
| Nonfat Dry Milk-Low Heat | 10.00 |
| Cocoa | 6.00 |
| Sodium Citrate | 0.10 |
| Disodium Phosphate Buffer | 0.10 |
| Salt | 0.08 |
| Flavor | 0.03 |

Procedure for manufacturing conventional hot fudge ice cream topping. Half of the water is metered into the liquivertor and the agitator is started. The disodium phosphate, salt, sodium citrate, and flavor are added to the water in the liquivator, and mixed for one minute. The nonfat dry milk is then added and mixed for an additional two minutes. The cocoa is added next; the mixture is mixed for three additional minutes. Next the sugar is added. The resulting mixture is mixed for one minute and then pumped into the mix kettle.

The remainder of the water and the corn syrup solids are added to the liquivertor, followed by the vegetable fat. The water, corn syrup solids, vegetable fat mixture is heated to 150° F. to melt the fat, and then the slurry from the mix kettle, prepared in the previous steps, is added to form a batch of hot fudge topping.

The cooker coils of the cook deck are then washed with approximately 25 gallons of water in preparation for pulling the batch of hot fudge topping to the cook deck. Once the coils are cleaned, the batch of hot fudge topping is pulled to the cook deck with partial vacuum. When the coils are covered with the hot fudge sauce, heating is started. The hot fudge sauce is heated to 215° F. and held at 215° F. for five minutes. A vacuum is then pulled, and the hot fudge topping is cooked at 170-180° F. to 71 brix. The hot fudge topping is released at 170° F.

The final brix of the hot fudge topping is checked. If brix are 70-73.0, the batch of hot fudge topping is sent to the homogenizer. If the brix are less than 70.0, the batch of hot fudge topping is blended with a higher brix batch. Once the brix of the hot fudge topping is 70-73.0, and the topping is in the homogenizer, the hot fudge topping is homogenized at 3000 psi. After homogenization, and with the temperature above 160° F., the hot fudge topping is sent to the filler. The hot fudge topping is filled into containers, sealed, and pasteurized.

### EXAMPLE 4

### Comparative Example—Typical Caramel Topping Formula

Product Solids 74.0%

| Ingredient | % |
|---|---|
| Corn Syrup Solids | 66.00 |
| Water | 28.57 |
| Nonfat Dry Milk | 3.00 |
| Corn Starch | 1.00 |
| Flavor | 0.60 |
| Salt | 0.50 |
| Sodium Alginate | 0.17 |
| Color | 0.06 |
| Disodium Phosphate | 0.05 |
| Sodium Citrate | 0.05 |

In a liquivertor, half of the sweeteners and the water are metered in, and the agitator is started. The sodium alginate is slowly added and the mixture is allowed for mix for two minutes. The disodium phosphate, salt and sodium citrate are then added and the mixture is allowed to mix for one minute. Nonfat dry milk is then added; the mixture is again mixed for one minute. The starch is then slowly added to the mixture. After the starch is added, the flavor is added. The mixture is mixed for one minute and then is transferred to the Mix Kettle.

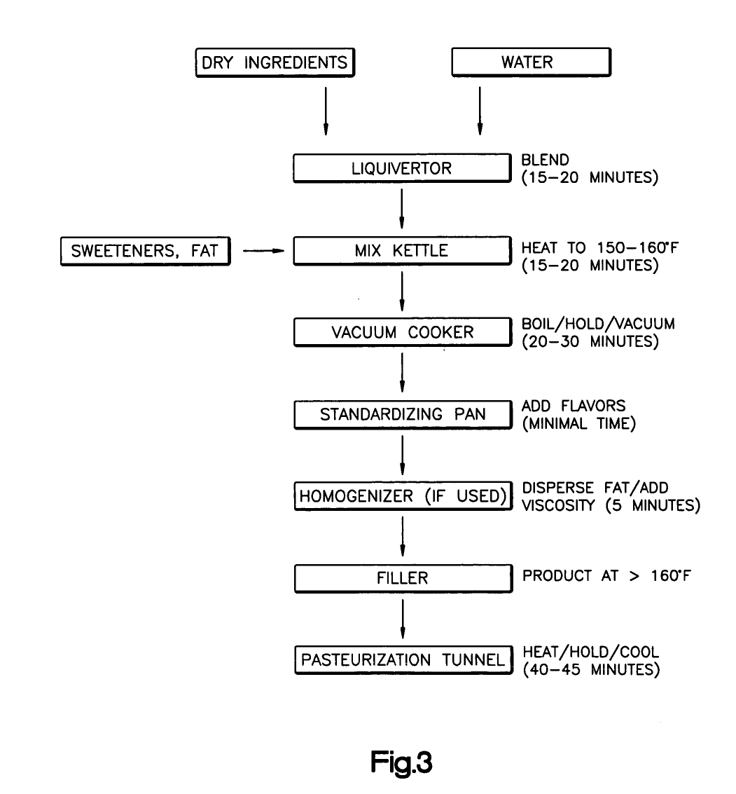

To the mixture in the mix kettle, the remainder of the sweeteners and water is added, followed by the color. The resulting slurry is then pumped into the liquivertor, the precooked solids are checked and recorded, and the slurry mixture is heated to 150° F. The cool deck is then washed with 15 gallons of water, in preparation for pulling the batch of topping to the cool deck. The batch is then pulled to the cool deck under partial vacuum (13-15″). The batch of caramel topping is then heated to 210° F., and held at 210° F. for five minutes. The caramel topping is then cooked to 74 brix at 170-175° F. The resulting caramel topping is released at a temperature of 170-175° F. and 74.0 brix. A diagram of this process is set forth in FIG. 3.

When the low A_{w} food product of the present invention is a filling, typical uses for the filling include: insertion of the filling into a cracker, wafer, cookie, biscuit, pretzel, donut, muffin, cake, waffle, or the like. The filling is formulated to be stable so that the filling can be packaged for later use, inserted onto and/or into a food casing for immediate or later, consumption, and/or inserted onto and/or into a food casing which is frozen and thawed and/or heated for later consumption. The filling is freezer stable so that after it is thawed, the filling does not substantially degrade. The filling is also formulated to have thermal durability. The filling is also formulated to have a low water activity. Heretofore, fillings such as fruit fillings, typically had water activities above about 0.6. Such high water activities for the filling typically resulted in the migration of the water from the filling into a food casing adjacent to or surrounding the filling, thereby resulting in the food, casing becoming soggy and/or otherwise becoming unacceptable for consumption. The lower water activity of the filling of the present invention overcomes the problems associated with high water activities of past fillings.

The filling material generally comprises flavoring agents, edible oils and humectant. The flavoring agent typically includes natural and/or artificial flavorings, such as fruit puree, fruit puree concentrate, fruit juice, fruit juice concentration, fruit concentrate, fruit flakes, fruit powder, vegetable puree, vegetable puree concentrate, vegetable juice, vegetable juice concentrate, vegetable pieces, vegetable concentrate, vegetable flakes, vegetable powder, artificial fruit, artificial fruit concentrate, artificial vegetables, artificial vegetable concentrate, dried fruit, dried vegetables, fruit extract, vegetable extract, cocoa, caramel, caramel powder, maple syrup, spies, chocolate, herbs, cheese, and/or flavored oils. Generally, the flavor agent that includes little or no water is added to the filling so as to minimize the water content of the final filling. As can be appreciated, the particular type of flavor agent and/or combination of flavoring agent used in the filling is dependent on the final use of the filling. The flavoring agent is added to the filling in a sufficient amount to provide the desired flavor of the final filling. The edible oil and humectant are added to provide flowability to the filling without the need to add water to the filling. The filling also typically includes, but does not require, sweetener and/or lecithin. The sweetener provides the desired sweetness to the final filling product. The lecithin functions as a emulsifier for the final filling. A general formulation for the filling comprises:

| Ingredient | Percent By Weight |
|---|---|
| Flavor Agent | about 0.05-50% |
| Edible Oil | about 0.01-80% |
| Humectant | about 0.1-40% |
| Sweetener | about 1-80% |
| Lecithin | about 0.01-10% |

A more specific formulation of the filling comprises:

| | |
|---|---|
| Fruit | about 0-25% |
| High Melting Point Oil | about 0-2% |
| Low Melting Point Oil | about 10-55% |
| Humectant | about 10-30% |
| Sweetener | about 30-45% |
| Lecithin | about 0.1-2% |
| Starch | about 1-40% |
| Stabilizer | about 0-18% |
| Acidulant | about 0.1-2% |
| Flavoring Agent | about 0.1-2% |
| Coloring Agent | about 0.01-2% |

A comparative example of a low A_{w} filling is set forth below:

### EXAMPLE 5

### Comparative Example “Strawberry Filling”

| | Weight | |
|---|---|---|
| Filling Material | Percentage | % Solids |
| Strawberry-Apple Flakes | 5.24 | 4.98 |
| Apple Powder | 10 | 10 |
| High Melting Point Oil | 1 | 1 |
| Low Melting Point Oil | 19 | 19 |
| Humectant | 20 | 19.9 |
| Powdered Sweetener | 23.56 | 23.56 |
| Liquid Sweetener | 17.3 | 13.32 |
| Lecithin | 0.2 | 0.198 |
| Instant Modified Starch | 2 | 1.9 |
| Flavored Strawberry | 1 | 0.57 |
| Malic Acid | 0.6 | 0.6 |
| Tater Red | 0.1 | 0.1 |

In the comparative example for strawberry filling illustrated above, the percent solids represent the non-water content of the low A_{w} food product. This filling has a water content of less than about 6 weight percent and a water activity of less than about 0.5.

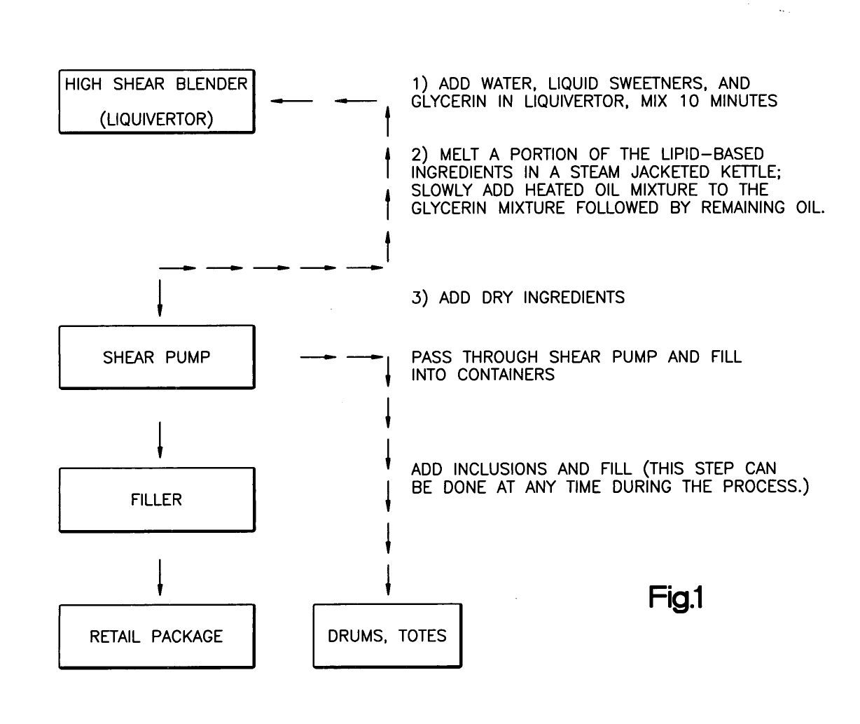

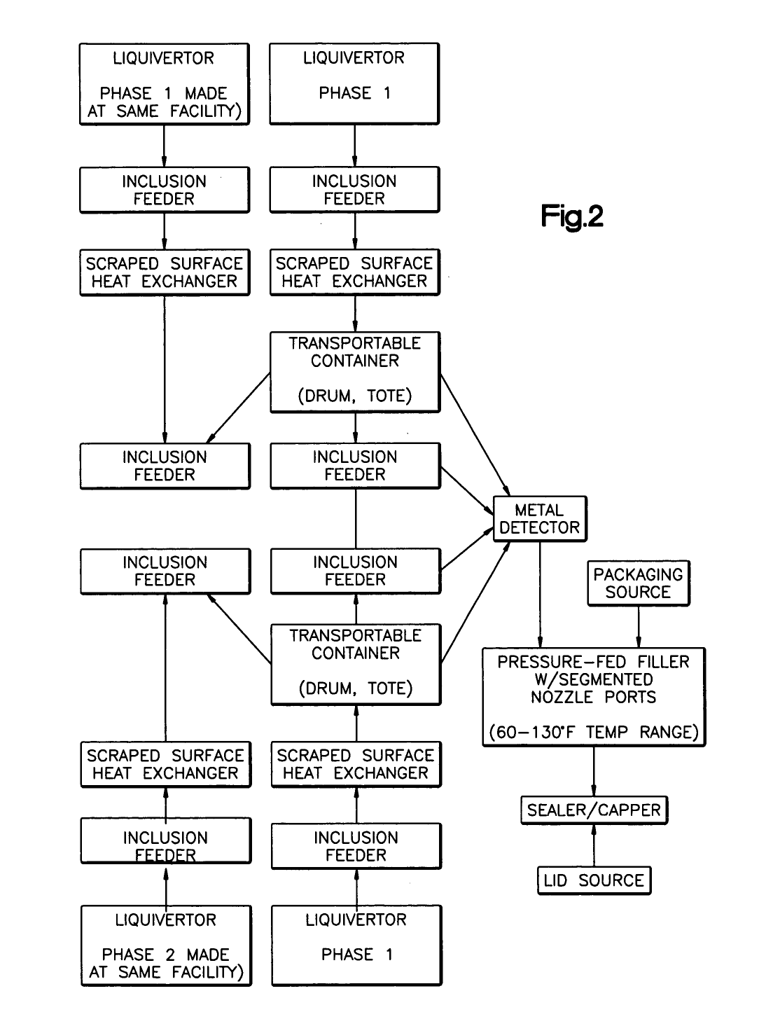

One process for making the food product compositions of the present invention is illustrated in FIG. 1. The method comprises first adding the glycerin, water, and liquid sweeteners and mixing. Next, the lipid-based components are mixed together and heated until all are melted. The melted lipid-based products are then slowly added to the glycerin mixture. After the lipids are added to the glycerin mixture, the remaining solid ingredients are added and mixed. The finished product is then filled into containers. When inclusions are desired in the low A_{w} food product, they may be added just prior to filling and sealing of the low A_{w} food product. When a multiphase product is desired, a pressure-fed filling head with segmented nozzle ports can be used to introduce the multiple phases to the fill container as shown in FIG. 2. In this way, multi-phased, striped low A_{w} food products can be made.

In illustrative FIG. 1, inclusions are added to the finished mixture after it is cooled to 95-100° F. The finished ice cream topping may be cooled further depending on the inclusions that are to be added. For example, if the inclusions are chocolate chips, or candy bar bits, it would be desirable cool the mixture to below the melting point of chocolate, so that they will not melt in the product. When the inclusions are nut meats, however, they can be added at a higher temperature and maintain their flavor, texture, and crispness.

When making a multiphase product, each phase may be made in accordance with the process set forth in FIG. 1. Alternatively, the different phases may be made by alternative processes for making low A_{w} food products. FIG. 2 illustrates a process for preparing a multi-phased ice cream topping, such as an ice cream topping that has a chocolate phase and a caramel phase. Other multi-phased food products, such as spreads, sauces, and so forth, can be produced by the same process. The starting points in FIG. 2 show each phase of the prepared low A_{w} food product in a separate liquivertor. From the liquivertors, each phase to be added to the final low A_{w} food product goes to a scraped surface heat exchanger wherein it is cooled to the desired temperature. For the ice cream application, each phase is cooled to approximately 95-100° F. The cooled product is then moved to a holding tank. It should be noted that when inclusions are desired in one or more phases of the final product, the inclusions may be added to the individual phases either during the initial manufacturing step, as in the process of FIG. 1. Alternatively, as illustrated in FIG. 2, the inclusions may be added either before or after the heat exchange step, or before the holding tank. The individual phases then go from the holding tank, through a metal detector, and to a pressure-fed filler with segmented nozzle ports. The temperature range for filling is approximately 60-130° F., and will depend on the identity of the phases of the multiphase low A_{w} food product. The pressure-fed filler with segmented nozzle ports allows the production of a multiphase striped or swirled product.

FIG. 2 further illustrates the process of making a multiphase product (1) when both phases are made at the same facility, and (2) when one phase is prepared at one facility and the second phase is prepared at another facility. This illustrates that when preparing a multi-phased product, both phases may be produced simultaneously, both phases may be prepared beforehand, either at the same or at different facilities. Similarly, when the multiphase product contains more than two phases, each phase may be prepared at the same facility or at different facilities.

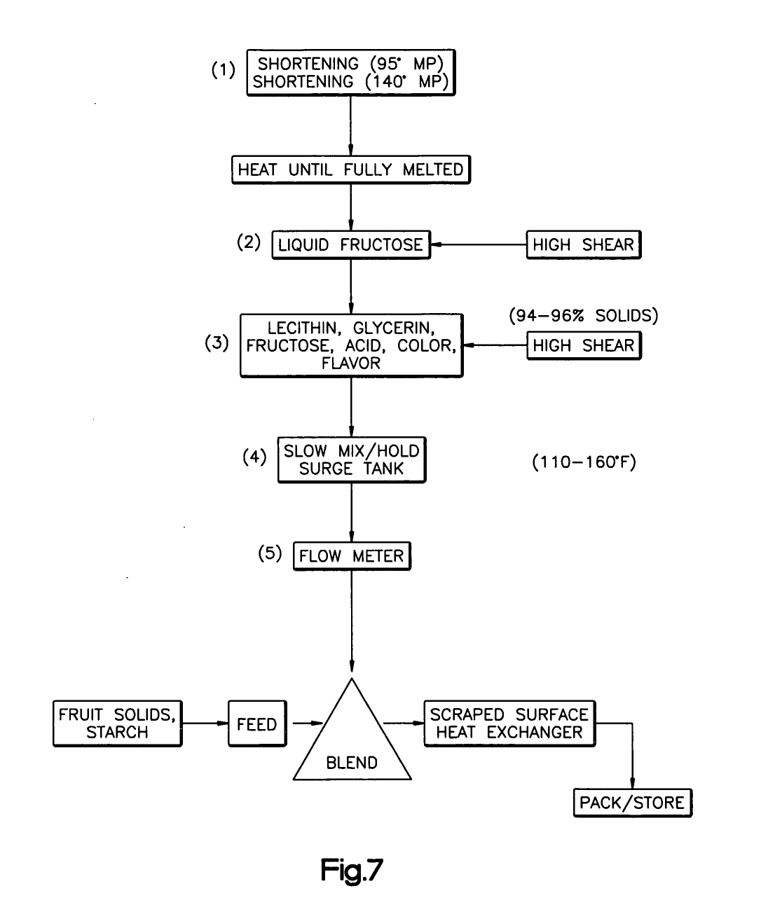

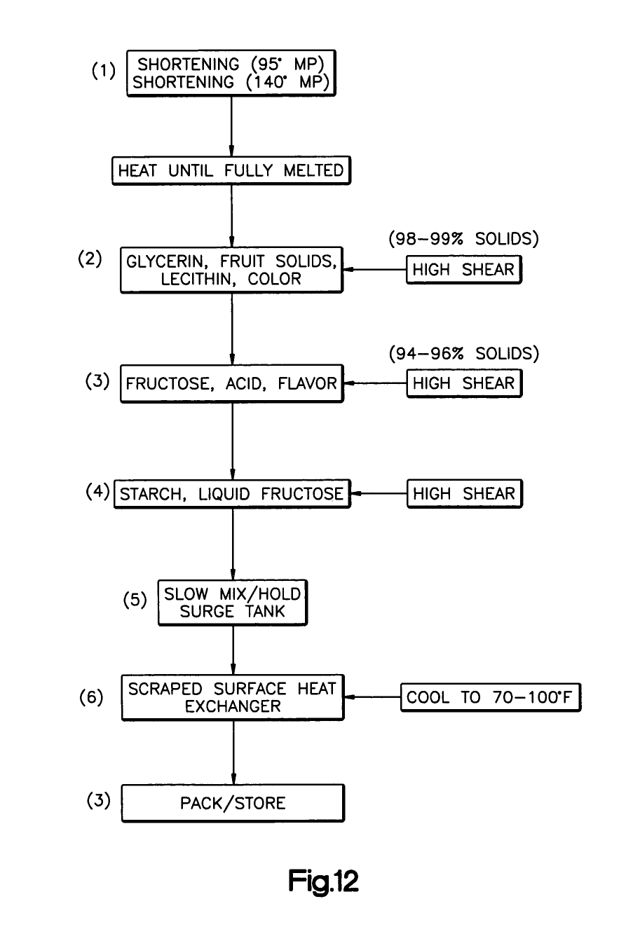

The process for manufacturing the low A_{w} fillings is illustrated in FIGS. 7 and 12. FIG. 7 illustrates a continuous process for manufacturing the low A_{w} fillings. FIG. 12 illustrates a batch process for manufacturing the low A_{w} fillings. In both processes, a fruit low A_{w} filling is illustrated; however, non-fruit low A_{w} food products can be manufactured by both these processes. Additionally, other low A_{w} food products, such as ice cream toppings, sauces, spreads, icings, and so forth may be prepared by the processes illustrated in FIGS. 7 and 12.

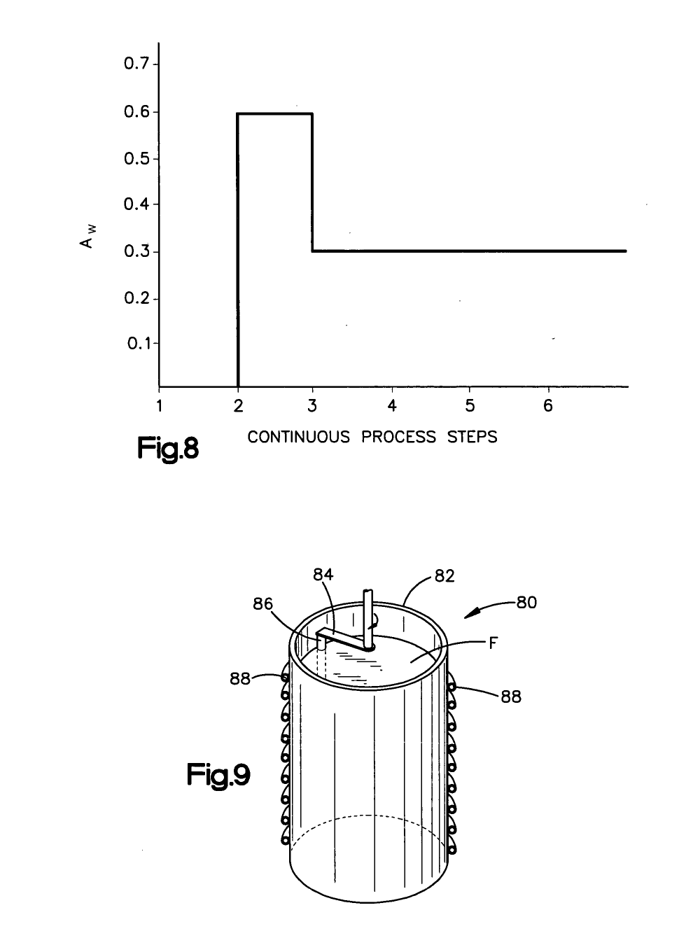

Referring now to FIG. 7, the principal process steps are numbered. These numbered process steps correspond to the graphical illustration of the water activity of the low A_{w} food product during manufacture as illustrated in FIG. 8. As shown in FIG. 7, the first process step involves the melting of the one or more edible oils. Step two illustrates the low A_{w} food product including two edible oils or shortenings, one shortening having a melting point of 95° F., referred to as a low melting point oil, and the other shortening has a melting point of 140° F., referred to as a high melting point oil. The two shortenings are heated to a temperature of about 150° F. and mixed together so as to fully melt the two shortenings. At this point of the process, the low A_{w} food product has essentially no moisture and theoretically no A_{w}. Therefore, as shown in FIG. 8, the water activity when the two shortenings are melted together is close to 0.

In step two of the process, liquid fructose is added to the melted shortening and dispersed therein by high shear mixing. The addition of liquid fructose adds fluidity to the mixture. The liquid fructose includes some water in the fructose, typically an 80/20 fructose syrup. As shown in FIG. 8; the addition of liquid fructose to the melted shortening increases the water activity of the low A_{w} food product to about 0.60.

In step three of the process, lecithin, glycerin, dried fructose, acid, coloring agents, and flavoring agents are added to the shortening and liquid fructose mixture. At this step, the water content of the filing is very low as indicated by the overall solids content of 94-95%. As shown in FIG. 8, in step three of the process, the water activity of the mixture decreases to about 0.30. These components are mixed in high shear conditions to disperse the components in the mixture.

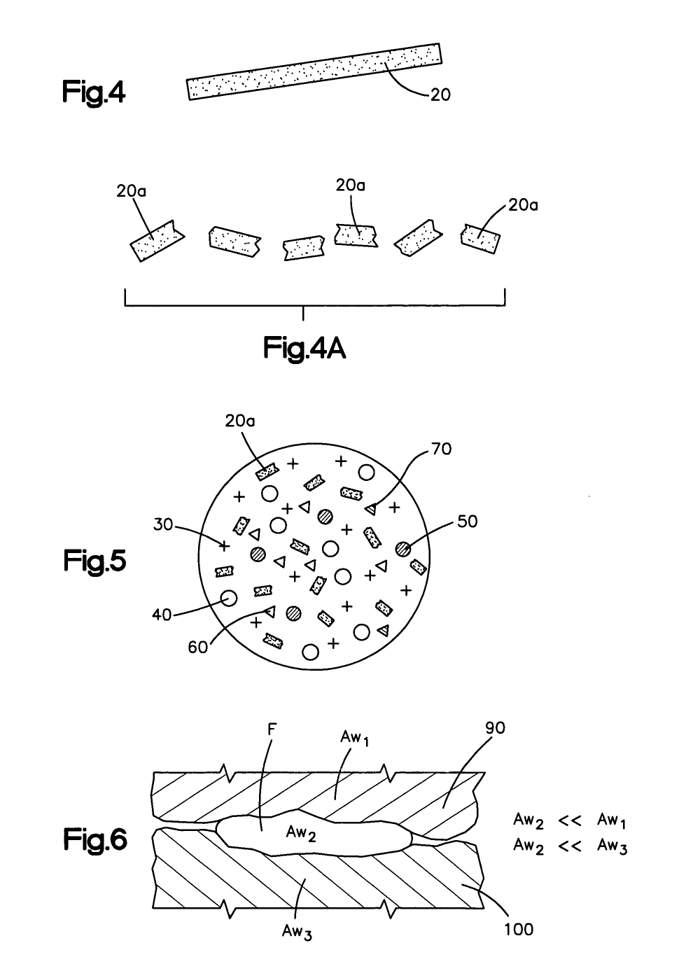

In step four of the process, the mixture is held in a surge tank and mixed. The temperature of the mixture is held to about 110-160° F. The cooling of the mixture below the melting point of the high melting point oil results in the high melting point oil to begin to crystallize. FIG. 4 illustrates a typical shortening crystal 20 which forms during step four of the process. Once the high melting point oil begins to crystallize, these crystals act as seeding agents for crystallization of other components in the low A_{w} food product such as, but not limited to, the low melting point oil and the sweetener. As illustrated in FIG. 8, the water activity of the low A_{w} food product does not increase during the mixing of the components.

In step five of the process, the mixture is directed through a flow meter and into a blender as designated by step six. The mixture is blended with fruit solids and starch in step 6. As illustrated in FIG. 8, the water activity remains relatively constant at about 0.30 when the fruit solids and starch are added to the mixture during the blending step. The fruit solids and starch are typically in a powdered or dry state, thus have a low water content so as not to substantially increase the water activity of the low A_{w} food product. The fruit solids and starch are fed into a blender in step six of the process and substantially fully dispersed with the shortening-sweetener mixture. Various types of blenders can be used to blend the components together. Such blenders include, but are not limited to, a triblender or a static blender.

Once the components are blended together, the mixed components are directed to a scraped surface heat exchanger to further cool the low A_{w} food product components. FIG. 9 illustrates a standard scraped surface heat exchanger 80. Scraped surface heat exchanger 80 includes a container 82, wherein the low A_{w} food product components are directed therein. While the low A_{w} food product components F are maintained in the container 82 of the scraped surface heat exchanger, a rotating arm 84 rotates a scraper blade 86 along the inner surface of container 82. Scraper blade 86 causes the crystals that have formed, or are in the process of forming, in filler F to be fractured. FIG. 4A illustrates the fracturing of a high melting point oil crystal in the scraped surface heat exchanger. Fractured crystals 20a continually grow and become refractured as the mixture is cooled and as scraper blade 86 rotates along the interior surface of container 82. A cooling jacket 88 surrounds the outer surface of container 82 allowing a cooling fluid, such as water, cooling gases, and/or cooling liquids, to pass therethrough. The flow of the cooling fluid through the cooling jacket 88 causes cooling of container 82, which in turn causes the low A_{w} food product components within container 82 to decrease in temperature. The low A_{w} food product components are maintained in the scraped surface heat exchanger until the temperature of the low A_{w} food product component is between about 40-110° F., and typically about 40-100° F., and more typically about 40-90° F. The final crystal size of the shortening in final low A_{w} food product F after the low A_{w} food product is cooled and passed through the scraped surface heat exchanger, it is about 1-30μ, and typically about 1-10μ and more typically about 1-5μ. FIG. 5 illustrates final low A_{w} food product F which includes fractured shortening 20a dispersed with the fruit solids 30, starch 40, glycerin 50, humectant 60, and fructose 70. The final low A_{w} food product has a water activity of less than about 0.4 and a water content of less than about 5.5 weight percent. This water activity is significantly less than the 0.7 water activity and 25 weight percent water of standard fruit low A_{w} food products. Although the fruit low A_{w} food product has significantly less water and a significantly lower water activity of standard fruit low A_{w} food products, the texture, taste, post processability, and other organoleptic characteristics are similar to those of standard fruit low A_{w} food products.

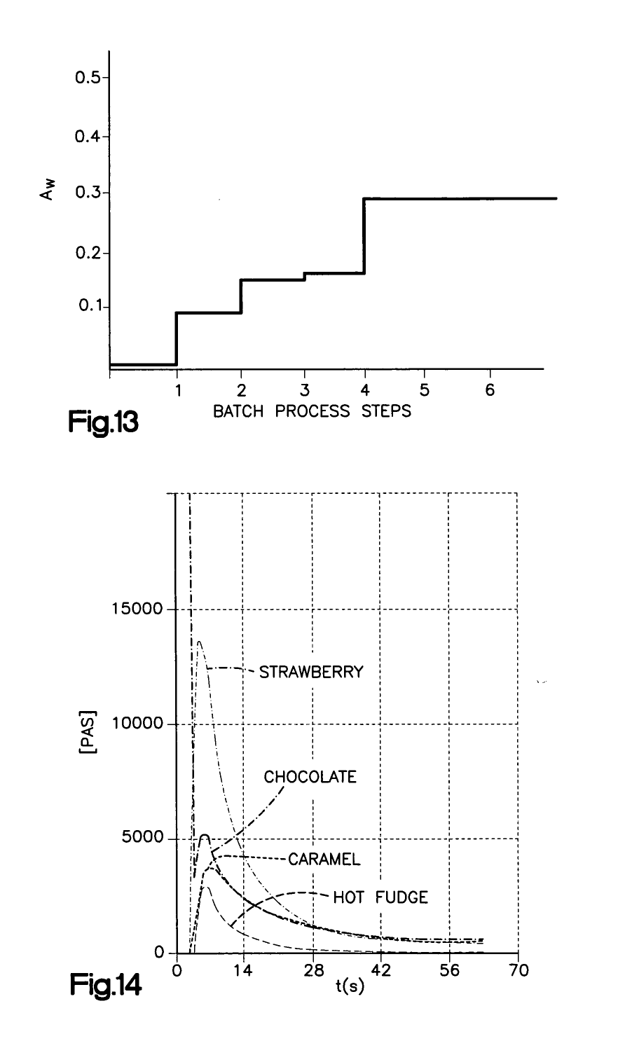

Referring now to FIG. 12, a batch process for manufacturing the low A_{w} food product is illustrated. The principal process steps are numbered. These numbered process steps correspond to the graphical illustration of the water activity of the low A_{w} food product during manufacture as illustrated in FIG. 12. In the batch process, the high melting point shortening and low melting point shortening are heated during step 1 until fully melted. The water activity of the oils is zero or very close to zero. After the shortenings are melted, glycerin, fruit solids, lecithin, and/or color are mixed with the shortening under high shear mixing conditions in step 2 so as to disperse these components into the melted shortening. The water activity of the mixture increases to about 0.153 during this step. In step 3, powdered fructose, acid and flavoring are then mixed with the other components of the low A_{w} food product under high shear conditions to substantially fully disperse the components of the mixture. The water activity of the mixture slightly increases to about 0.157. Finally, liquid fructose and starch are added to the mixture under high shear conditions in step 4. The liquid fructose and starch are added last to delay starch hydration and premature viscosity build-up of the low A_{w} food product components. The water activity of the mixture increases to about 0.3 during step 4. The mixture is then mixed and held in a surge tank to about 110-160° F. During the cooling process, the high melting point oil begins to crystallize. After the mixture has been held in, the surge tank for a sufficient amount of time and tempered to the desired temperature, the mixture is transferred to a scraped surface heat exchanger, wherein the mixture is cooled to a temperature between about 40-110° F. Once the desired crystal size and temperature of the low A_{w} food product is obtained in the scraped surface heat exchanger, the low A_{w} food product is transferred to packaging and stored for later use. Typically, the low A_{w} food product, after being packaged, is stored at ambient room temperature. The water activity of the mixture remains substantially constant during steps 5 and 6. As illustrated in FIGS. 8 and 13, the water activity profile of the mixture is different in a batch or continuous process. However, in both processes, the final water activity of the low A_{w} food product is about 0.3.

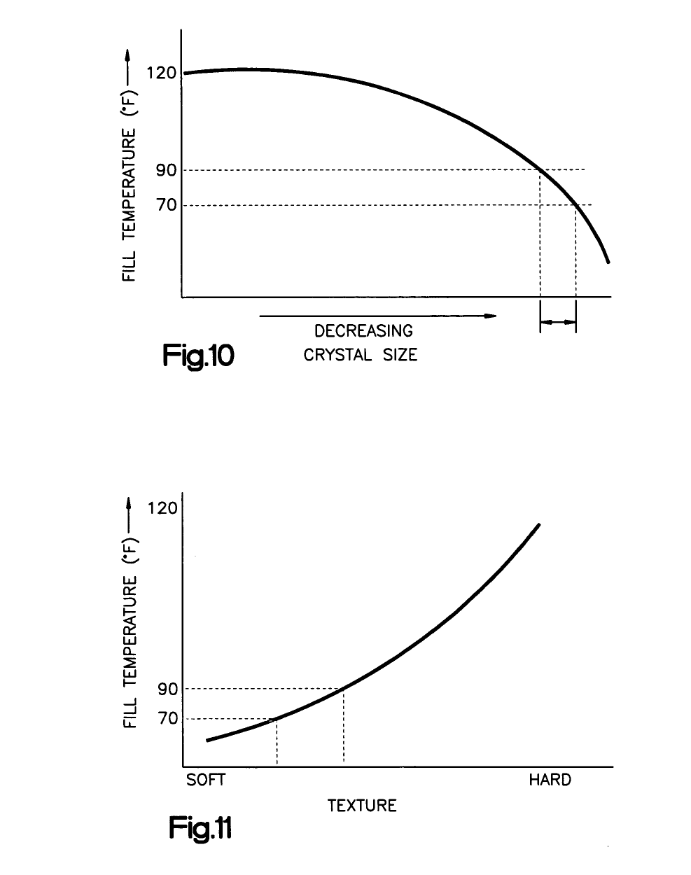

FIGS. 10 and 11 graphically illustrate the relationship of the crystal size and texture of the low A_{w} food product as a function of the temperature of the low A_{w} food product when it is removed from the scraped surface heat exchanger. As shown in FIG. 10, when the low A_{w} food product is removed from the scraped surface heat exchanger at about 110°-120° F., the crystal size of the final low A_{w} food product will be relatively large. When the low A_{w} food product is removed from the scraped surface heat exchanger at a temperature of about 77-90° F., the crystal size of the shortening is substantially smaller. As shown in FIG. 11, a correlation exists between smaller crystal sizes and softer low A_{w} food product textures. Low A_{w} food product having a smaller crystal size and which is removed from the scraped surface heat exchanger at a lower temperature has a smoother texture. Low A_{w} food product having a larger crystal size and which is removed from the scraped surface heat exchanger at a higher temperature has a harder texture. It is believed that when the low A_{w} food product is removed from the scraped surface heat exchanger at temperatures above 110° F., substantial crystal growth continues as the low A_{w} food product cools to or below ambient temperature (70′-77° F.). This continued crystal growth results in larger crystals in the final low A_{w} food product and increased textural hardness of the low A_{w} food product. However, it is believed that when the crystals are continually fractured as the filing temperature falls below 110° F., the growth rate of the crystals is significantly less after the low A_{w} food product is removed from the scraped surface heat exchanger and allowed to further cool to or below ambient temperature. Cooling the low A_{w} food product to low temperatures is also believed to help stabilize the final low A_{w} food product. As a result, the final low A_{w} food product has smaller crystals and a softer texture. The use of the high melting point oil as a seed for crystallization causes crystallization of the filler components at higher temperatures, thereby resulting in a more stabilized product after the crystals are fractured which in turn allows the low A_{w} food product to be packaged at higher temperatures and maintain a soft texture with increased stability. It has also been found that when the low A_{w} food product is reheated and cooled, the texture of the low A_{w} food product is not significantly altered. Furthermore, when the low A_{w} food product is cooled to lower temperatures in the scraped surface heat exchanger, significantly less shortening separation from the low A_{w} food product occurs during packaging, storage and reheating, thereby resulting in a more stable low A_{w} food product. The soft textured low A_{w} food product has desired flowability characteristic such that the low A_{w} food product can be easily pumped or extruded for packaging for future use, or be inserted on or into a final food product.

Referring now to FIG. 6, a food product is illustrated, wherein low A_{w} food product F is inserted between two layers of food casing 90, 100. Food casings 90, 100 can constitute a wide variety of food casings such as layers of crackers, cookies, crunchy granola bars, crusts, and the like. As shown in FIG. 6, the water activity of the low A_{w} food product is less than the water activity of food casing layers 90, 100 thus resulting in moisture from low A_{w} food product F not migrating to either food layer 90 or 100. As a result, the low water activity low A_{w} food product F does not cause the boundary between low A_{w} food product F and the food layers to become soggy or to cause degradation of the food casings.

FIG. 14 compares the rheologies of two inventive ice cream toppings, one caramel and one chocolate with a conventional hot fudge ice cream topping and with a strawberry Low A_{w} filling. As can be seen from the graph, the Low A_{w} ice cream toppings of the present invention have rheological properties that are very similar to those of the conventional hot fudge ice cream toppings. The strawberry Low A_{w} filling is quite different Theologically, indicating that it is not nearly as flowable as the inventive Low A_{w} ice cream toppings.

The invention has been described with reference to a preferred embodiment and alternatives thereof. It is believed that many modifications and alterations to the embodiments disclosed will readily suggest itself to the those skilled in the art upon reading and understanding the detailed description of the invention. It is intended to include all such modifications and alterations insofar as they come within the scope of the present invention.

1. A low water activity (A_{w}) food product comprising:
a) 0.05% to 40% by weight flavor agent;
b) 0.01% to 50% by weight of one or more fats, wherein the fats have a melting point in the range from 35° F. to 150° F.;
c) 0.1% to 40% by weight humectant;
d) up to 80% by weight sweetener; and
e) up to 10% by weight emulsifier;
wherein the low A_{w} food product contains 0% to 20% water and has an A_{w} of up to 0.85.

2. The low A_{w} food product of claim 1 wherein the flavorant is selected from the group consisting of natural flavorants, artificial flavorants, flavor enhancers, and combinations thereof.

3. The low A_{w} food product of claim 1 wherein up to 20% of the flavor agent comprises one or more dairy-based flavor agents selected from the group consisting of whey, whey protein concentrate, buttermilk powder, nonfat dry milk, milk powder, lactose, and combinations thereof.

4. The low A_{w} food product of claim 1 wherein the flavor agent is selected from the group consisting of cocoa, cocoa substitute, dutched cocoa, chocolate herbs, chocolate, caramel, caramel powder, maple syrup, nut, hazelnut, almond, cashew, macadamia, pecan, walnut, peanut, peanut butter, marshmallow, vanilla, vanilla extract, imitation vanilla extract, mint, spearmint, peppermint, wintergreen, creme de menthe, cinnamon, herbs, spices, oils, extracts, vegetables, vegetable extracts, fruits, fruit extracts, cream, cream cheese flavor, cheese, whey, whey protein concentrate, buttermilk powder, nonfat dry milk, milk powder, lactose, and combinations thereof.

5. The low A_{w} food product of claim 1 comprising 1% to 40% fat, by weight.

6. The low A_{w} food product of claim 5 comprising 5% to 30% fat, by weight.

7. The low A_{w} food product of claim 1 wherein the fat is a vegetable fat.

8. The low A_{w} food product of claim 1 wherein the fat has a melting point that is less than 99° F.

9. The low A_{w} food product of claim 1 comprising 1% to 30% humectant, by weight.

10. The low A_{w} food product of claim 1 wherein the humectant is selected from the group consisting of glycerin, 1,3-butyl glycol, mannitol, sorbitol, fructose, propylene glycol, and combinations thereof.

11. The low A_{w} food product of claim 10 wherein the humectant is glycerin.

12. The low A_{w} food product of claim 1 wherein the fat plus humectant comprises 20% to 70% of the low A_{w} food product, by weight.

13. The low A_{w} food product of claim 12 wherein the fat plus humectant comprises 20% to 60% of the low A_{w} food product, by weight.

14. The low A_{w} food product of claim 13 wherein the fat plus humectant comprises 30% to 55% of the low A_{w} food product, by weight.

15. The low A_{w} food product of claim 14 wherein the fat plus humectant comprises 35% to 50% of the low A_{w} food product, by weight.

16. The low A_{w} food product of claim 1 comprising up to 50% sweetener, by weight.

17. The low A_{w} food product of claim 16 comprising 10% to 50% sweetener, by weight.

18. The low A_{w} food product of claim 17 comprising 30% to 45% sweetener, by weight.

19. The low A_{w} food product of claim 1 wherein the sweetener is selected from liquid sweeteners, solid sweeteners, and combinations thereof.

20. The low A_{w} food product of claim 19 wherein the sweetener is selected from the group consisting of sucrose, dextrose, fructose, lactose, malt syrup, malt syrup solids, rice syrup, rice syrup solids, invert sugar, refiners syrup, corn syrup, high fructose corn syrup, corn syrup solids, maltose, fructose syrup, honey, molasses, grain syrups, agave, aspartame, sucrolose, saccharine, and combinations thereof.

21. The low A_{w} food product of claim 1 comprising 0.01% to 5% emulsifier, by weight.

22. The low A_{w} food product of claim 1 wherein the emulsifier is selected from the group consisting of lecithin, glycerol esters, diacetyl tartaric acids, esters of monoglycerides, mono- and diglycerides, polyglycerol esters, polysorbate, propylene glycol esters, rice extract esters, sodium stearoyl-2-lactylate, sorbitan esters, sugar esters, acetylated monoglycerides and combinations thereof.

23. The low A_{w} food product of claim 22 wherein the emulsifier is lecithin.

24. The low A_{w} food product of claim 1 wherein the water activity is less than or equal to 0.7.

25. The low A_{w} food product of claim 24 wherein the water activity is less than or equal to 0.65.

26. The low A_{w} food product of claim 25 wherein the water activity is less than or equal to 0.6

27. The low A_{w} food product of claim 1 wherein the water activity is less than or equal to 0.5.

28. The low A_{w} food product of claim 1 comprising less than 25% water, by weight.

29. The low A_{w} food product of claim 28 comprising 1% to 15% water, by weight.

30. The low A_{w} food product of claim 29 comprising 1% to 10% water, by weight.

31. The low A_{w} food product of claim 1 comprising 0.01% to 15% starch, by weight.

32. The low A_{w} food product of claim 31 comprising 0.1% to 5% starch, by weight.

33. The low A_{w} food product of claim 1 wherein the food product further contains inclusions.

34. The claim 33 wherein the inclusions are selected from the group consisting of crumbs, nuts, nut meats, roasted nuts, peanuts, seeds, confections, candies, hard candies, chocolate candies, candy bar bits, caramels, peanut butter candy, peanut butter cups, candy-coated chocolates, chocolate chips, chocolate chunks, malted milk balls, granola, cookies bits, pie crust bits, cake bits, dehydrated marshmallows, brownie bits, and combinations thereof.

35. The low A_{w} topping of claim 33 wherein the inclusions are coated with a moisture barrier, wherein the barrier prevents migration of water into the inclusions.

36. The low A_{w} topping of claim 35 wherein the moisture barrier comprises beeswax.

37. The low A_{w} topping of claim 36 wherein the moisture barrier further comprises a protein, an emulsifier, or a protein and an emulsifier;
wherein the protein is selected from the group consisting of whey protein (comprising α and β lactoglobulins), whey protein concentrate, zein, casein, soy protein, soy protein isolate, ovalbumin, serum albumin, seed protein, protein derived from other natural sources, and combinations thereof; and
wherein the emulsifier is selected from the group consisting of lecithin, glycerol esters, diacetyl tartaric acids, esters of mono and di-glycerides, mono and di-glycerides, polyglycerol esters, polysorbate, propylene glycol esters, sodium steroyl-2-lactylate, sorbitan esters, sugar esters, acetylated mono and di-glycerides, emulsifiers derived from either natural or synthetic sources, and combinations thereof.

38. The low A_{w} food product of claim 1, wherein the food product is selected from the group consisting of ice cream toppings, icings, desert spreads, sandwich spreads, dips, confections, fillings, and savory sauces.

39. The low A_{w} food product of claim 38 wherein the low A_{w} food product comprises more than one phase.

40. The low A_{w} food product of claim 39 comprising inclusions in at least one phase whereby the taste and texture of the inclusions are maintained in the low A_{w} food product.

41. The low A_{w} topping of claim 40 wherein the inclusions are selected from the group consisting of crumbs, nuts, nut meats, roasted nuts, peanuts, seeds, confections, candies, hard candies, chocolate candies, candy bar bits, caramels, peanut butter candy, peanut butter cups, candy-coated chocolates, chocolate chips, chocolate chunks, malted milk balls, granola, cookies bits, pie crust bits, cake bits, dehydrated marshmallows, brownie bits, and combinations thereof.

42. The low A_{w} topping of claim 41 wherein the inclusions are coated with a moisture barrier, wherein the barrier prevents migration of water into the inclusions.

43. The low A_{w} topping of claim 42 wherein the moisture barrier comprises beeswax.

44. The low A_{w} topping of claim 43 wherein the moisture barrier further comprises a protein, an emulsifier, or a protein and an emulsifier;
wherein the protein is selected from the group consisting of whey protein (comprising α and β lactoglobulins), whey protein concentrate, zein, casein, soy protein, soy protein isolate, ovalbumin, serum albumin, seed protein, protein derived from other natural sources, and combinations thereof; and
wherein the emulsifier is selected from the group consisting of lecithin, glycerol esters, diacetyl tartaric acids, esters of mono and di-glycerides, mono and di-glycerides, polyglycerol esters, polysorbate, propylene glycol esters, sodium steroyl-2-lactylate, sorbitan esters, sugar esters, acetylated mono and di-glycerides, emulsifiers derived from either natural or synthetic sources, and combinations thereof.

45. An ice cream topping having a low water activity (A_{w}) comprising:
a) 0.05% to 40% by weight flavor agent;
b) 0.01% to 50% by weight of one or more fats, wherein the fats have a melting point in the range from 35° F. to 150° F.;
c) 1% to 40% by weight humectant;
d) 1% to 80% by weight sweetener;
e) 0.01% to 5% by weight emulsifier;
f) 0 to 20% water; and
g) an A_{w} less than or equal to 0.75.

46. The ice cream topping of claim 45 comprising two or more phases.

47. The ice cream topping of claim 46 comprising inclusions in at least one of the phases.

48. The ice cream topping of claim 46 comprising a chocolate phase and a caramel phase.

49. The ice cream topping of claim 48 further comprising peanuts in the caramel phase.

50. A cold process for preparing a low A_{w} food product comprising the steps of:
a) melting fat-based ingredients in a high shear blender to make a liquid oil;
b) adding water and humectant to the liquid oil to form an emulsion;
c) recirculating the emulsion;
d) adding sweeteners, flavorants, and optionally dairy components to the emulsion; and
e) blending the emulsion to provide the low A_{w} food composition.

51. The process of claim 50 further comprising adding inclusions to the low A_{w} food composition during any of steps a, b, c, d, or e.

52. The process of claim 51 wherein the inclusions have been coated with a moisture barrier prior to adding to the low A_{w} food composition.

53. A process for making a multi-phase low A_{w} food product comprising the steps of:
a) preparing a first low A_{w} food product, the first low A_{w} food product prepared by the steps of:
i) melting fat-based ingredients in a high shear blender to make a liquid oil;
ii) adding water and humectant to the liquid oil to form an emulsion;
iii) recirculating the emulsion;
iv) adding sweeteners, flavorants, and optionally dairy components to the emulsion; and
v) blending the emulsion to provide the first low A_{w} food composition;
vi) optionally, adding inclusions to the first low A_{w} food product during any of steps a, b, c, d, or e;
b) preparing a second low A_{w} food product, wherein the second low A_{w} food product is prepared by the same steps as the first low A_{w} food product, and wherein the second low A_{w} food product has a different flavor from the first low A_{w} food product;
c) optionally preparing a third low A_{w} food product, wherein the third low A_{w} food product is prepared by the same steps as the first low A_{w} food product, and wherein the third low A_{w} food product has a different flavor from the first low A_{w} food product and the second low A_{w} food product;
d) optionally preparing a fourth low A_{w} food product, wherein the fourth low A_{w} food product is prepared by the same steps as the first low A_{w} food product, and wherein the fourth low A_{w} food product has a different flavor from the first low A_{w} food product, the second low A_{w} food product, and the third low A_{w} food product;
e) introducing the first low A_{w} food product, the second low A_{w} food product, and optionally the third low A_{w} food product, and optionally the fourth low A_{w} food product to a pressure-fed filler with segmented nozzle ports; and
f) releasing the first low A_{w} food product, the second low A_{w} food product, and optionally the third low A_{w} food product, and optionally the fourth low A_{w} food product simultaneously to create the multi-phase low A_{w} food product.
